(19) United States
(12) Patent Application Publication
(10) Pub. No.: US 2019/0128395 A1
(43) Pub. Date: May 2, 2019

(54) Differential Assembly With Bearing Assemblies

(71) Applicant: Dana Heavy Vehicle Systems Group, LLC, Maumee, OH (US)

(72) Inventors: Steven G. Slesinski, Ann Arbor, MI (US); Harry W. Trost, Royal Oak, MI (US)

(21) Appl. No.: 15/800,533

(22) Filed: Nov. 1, 2017

(51) Int. Cl. F16H 48/08; F16H 57/04

(52) U.S. Cl. CPC F16H 48/08; F16H 2048/405; F16H 57/0483

(57) ABSTRACT

A differential assembly for use in a vehicle. The differential assembly includes a differential case having an inner surface and an outer surface defining a hollow portion therein. At least a portion of a differential gear set having a first side gear, a second side gear and one or more pinion gears is disposed within the hollow portion of the differential case. The one or more pinion gears have one or more pinion gear apertures having at least a portion of one or more trunnions of a spider disposed therein. Interposed between an outer surface of the one or more trunnions of the one or more spiders and a surface defining the one or more pinion gear apertures is one or more first bearing assemblies.

### FIELD OF THE DISCLOSURE

The present disclosure relates to a differential assembly for use in a motor vehicle.

### BACKGROUND OF THE DISCLOSURE

It is well known within the industry to incorporate the use of a differential assembly within an axle system of a vehicle. The differential assembly allows the outer drive wheel(s) of the vehicle to rotate at a faster rate that the inner drive wheel(s) when the vehicle experiences a turning condition. In order to allow a differential action to occur within differential assembly of the vehicle, the differential assembly includes a differential gear set that is housed within a differential case. A conventional differential gear set includes a first side gear, a second side gear and one or more pinion gears that are drivingly connected to the first and second side gears of the differential gear set.

When one or more wheels of the vehicle experiences a spin-out condition, there is an increase in the amount of rotation between the differential case and the one or more pinion gears of the differential gear set. As the amount of rotation between the differential case and the one or more pinion gears increases, the amount of friction between the one or more pinion gears and the differential case increases. Once the amount of friction between the differential case and the one or more pinion gears of the differential assembly reaches a certain threshold, a spin-out failure occurs within the differential assembly. Typically, when a spin-out failure occurs, the amount of friction between the one or more pinion gears and the differential case has increased to the point that the one or more pinion gears have become friction welded to the differential case. Once the spin-out failure has occurred and the one or more pinion gears have become welded to the differential case, the differential assembly is prevented from allowing a differential action to occur and the vehicle experiences an increase in tire wear. It would therefore be advantageous to develop a differential assembly that will reduce the occurrence of and/or prevent the occurrence of a spin-out failure within the differential assembly of the vehicle.

### SUMMARY OF THE DISCLOSURE

The present disclosure relates to a differential assembly for use in a motor vehicle. The differential assembly includes a differential case having an inner surface and an outer surface defining a hollow portion therein. At least a portion of a differential gear set is disposed within the hollow portion of the differential case. The differential gear set includes a first side gear, a second side gear and one or more pinion gears. Extending from a radially outboard surface to a radially inboard surface of the one or more pinion gears is one or more pinion gear apertures.

The differential assembly further includes one or more spiders. The one or more spiders of the differential assembly has one or more trunnions extending from at least a portion of an outer surface of a body portion of the one or more spiders. At least a portion of the one or more trunnions are disposed within at least a portion of said one or more pinion gear apertures in said one or more pinion gears of the differential gear set.

Interposed between a surface defining the one or more pinion gear apertures and the outer surface of the one or more trunnions of the one or more spiders is one or more first bearing assemblies according to an embodiment of the disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic top-plan view of a vehicle having one or more differential assemblies according to an embodiment of the disclosure;

FIG. 2 is a schematic top-plan view of another vehicle having one or more differential assemblies according to an embodiment of the disclosure;

FIG. 3 is a schematic top-plan view of yet another vehicle having one or more differential assemblies according to an embodiment of the disclosure;

FIG. 4 is a schematic top-plan view of still yet another vehicle having one or more differential assemblies according to an embodiment of the disclosure;

FIG. 5 is a cut-away schematic side-view of a portion of a differential assembly according to an embodiment of the disclosure;

FIG. 6 is a cut-away schematic side view of a portion of a differential assembly according to an alternative embodiment of the disclosure;

FIG. 7 is a cut-away schematic side-view of a portion of a differential assembly according to another embodiment of the disclosure;

FIG. 8 is a perspective view of one or more first bearing assemblies according to an embodiment of the disclosure;

FIG. 9 is a perspective view of one or more first bearing assemblies according to an alternative embodiment of the disclosure;

FIG. 10 is a perspective view of one or more first bearing assemblies according to another embodiment of the disclosure

FIG. 11 is a schematic top-plan view of one or more second bearing assemblies according to an embodiment of the disclosure;

FIG. 11A is a partial cut-away schematic side view of the one or more second bearing assemblies illustrated in FIG. 11 of the disclosure;

FIG. 12 is a schematic perspective view of one or more second bearing assemblies according to an alternative embodiment of the disclosure;

FIG .13 is a cut-away schematic side-view of one or more second bearing assemblies according to another embodiment of the disclosure; and

FIG. 14 is a schematic perspective view of a spider according to an embodiment of the disclosure.

### DETAILED DESCRIPTION OF THE DISCLOSURE

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

It is within the scope of this disclosure, and as a non-limiting example, that the differential assembly disclosed herein may be used in automotive, off-road vehicle, all-terrain vehicle, construction, structural, marine, aerospace, locomotive, military, machinery, robotic and/or consumer product applications. Additionally, as a non-limiting example, the differential assembly disclosed herein may also be used in passenger vehicle, electric vehicle, hybrid vehicle, commercial vehicle, autonomous vehicles, semi-autonomous vehicles and/or heavy vehicle applications.

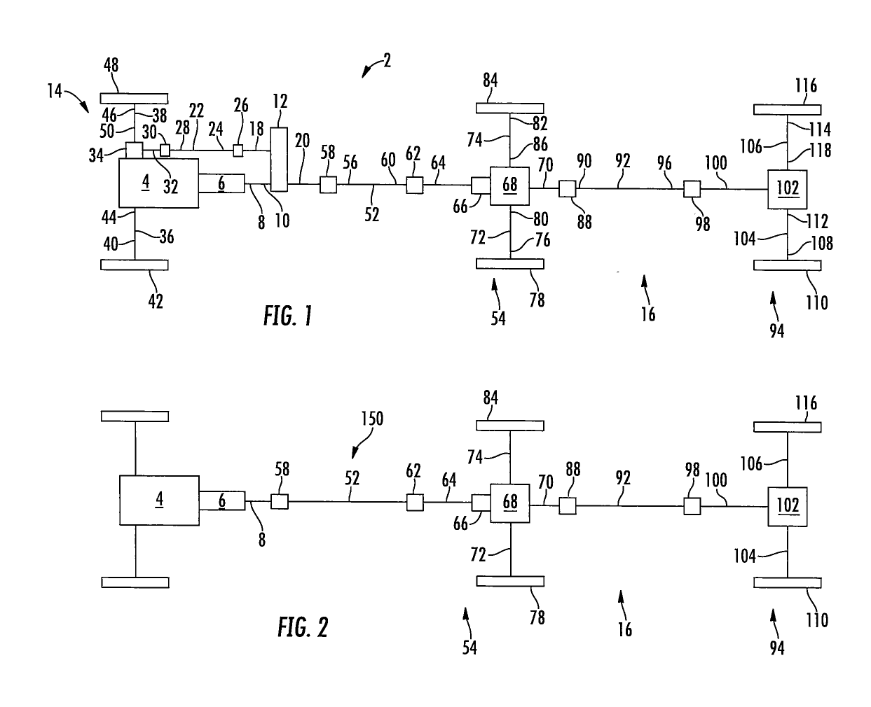

FIG. 1 is a schematic top-plan view of a vehicle 2 having one or more differential assemblies according to an embodiment of the disclosure. The vehicle 2 has an engine 4 which is drivingly connected to a transmission 6. As non-limiting example, the engine 4 of the vehicle 2 may be an internal combustion engine, an external combustion engine, an electric motor, a steam turbine and/or a gas turbine. A transmission output shaft 8 is drivingly connected to an end of the transmission 6 opposite the engine 4. The transmission 6 is a power management system which provides controlled application of the rotational energy generated by the engine 4 by means of a gearbox.

An end of the transmission output shaft 8, opposite the transmission 6, is drivingly connected to a transfer case input shaft 10 which in turn is drivingly connected to a transfer case 12. The transfer case 12 is used to selectively transfer the rotational power from the transmission 6 of the vehicle 2 to a front axle system 14 and a tandem axle system 16 by utilizing a series of gears and drive shafts. The transfer case 12 includes a first transfer case output shaft 18 and a second transfer case output shaft 20.

A first shaft 22 extends from the first transfer case output shaft 18 to the front axle system 14 thereby drivingly connecting the transfer case 12 to the front axle system 14 of the vehicle 2. As a non-limiting example, the first shaft 22 is a drive shaft, a prop shaft, a Cardan shaft, a double cardan shaft, a universal joint shaft or a universal coupling shaft. A first end portion 24 of the first shaft 22 is drivingly connected to an end of the first transfer case output shaft 18, opposite the transfer case 12, via a first joint assembly 26. As illustrated in FIG. 1 of the disclosure, a second end 28 of the first shaft 22 is drivingly connected to a second joint assembly 30.

Drivingly connected to an end of the second joint assembly 30, opposite the first shaft 22, is a front axle input shaft 32. In accordance with an embodiment of the disclosure and as a non-limiting example, the front axle input shaft 32 is a front differential input shaft, a coupling shaft, stub shaft or a front differential pinion shaft. Drivingly connected to an end of the front axle input shaft 32, opposite the first shaft 22, is a front axle differential 34 of the front axle system 14 of the vehicle 2. The front axle differential 34 is a set of gears that allows the outer drive wheel(s) of the wheeled vehicle 2 to rotate at a faster rate that the inner drive wheel(s). The rotational power is transmitted through the front axle system 14 as described in more detail below.

The front axle system 14 further includes a first front axle half shaft 36 and a second front axle half shaft 38. As illustrated in FIG. 1 of the disclosure, the first front axle half shaft 36 extends substantially perpendicular to the front axle input shaft 32 of the vehicle 2. A first end portion 40 of the first front axle half shaft 36 is drivingly connected to a first front axle wheel assembly 42 and a second end portion 44 of the first front axle half shaft 36 is drivingly connected to a side of the front axle differential 34. As a non-limiting example, the second end portion 44 of the first front axle half shaft 36 is drivingly connected to a front differential side gear, a separate stub shaft, a separate coupling shaft, a first front axle differential output shaft, a first front axle half shaft disconnect system and/or a shaft that is formed as part of a front differential side gear.

Extending substantially perpendicular to the front axle system input shaft 32 is the second front axle half shaft 38. A first end portion 46 of the second front axle half shaft 38 is drivingly connected to a second front axle wheel assembly 48. A second end portion 50 of the second front axle half shaft 38 is drivingly connected to a side of the front axle differential 34 opposite the first front axle half shaft 36. As a non-limiting example, the second end portion 50 of the second front axle half shaft 38 is drivingly connected to a front differential side gear, a separate stub shaft, a separate coupling shaft, a second front axle differential output shaft, a second front axle half shaft disconnect system and/or a shaft that is formed as part of a front differential side gear.

An end of the second transfer case output shaft 20 is drivingly connected to an end of the transfer case 12 opposite the transfer case input shaft 10. A second shaft 52 extends from the second transfer case output shaft 20 toward a forward tandem axle system 54 of the tandem axle system 16 of the vehicle 2. In accordance with an embodiment of the disclosure and as a non-limiting example, the second shaft 52 is a drive shaft, a prop shaft, a Cardan shaft, a double cardan shaft, a universal joint shaft or a universal coupling shaft. A first end portion 56 of the second shaft 52 is drivingly connected to an end of the second transfer case output shaft 20, opposite the transfer case 12, via a third joint assembly 58. As illustrated in FIG. 1 of the disclosure, a second end portion 60 of the second shaft 52 is drivingly connected to a fourth joint assembly 62.

Drivingly connected to an end of the fourth joint assembly 62, opposite the second shaft 52, is a forward tandem axle system input shaft 64. An end of the forward tandem axle system input shaft 64, opposite the fourth joint assembly 62, is drivingly connected to an inter-axle differential 66 of the forward tandem axle system 54 of the vehicle 2. The inter-axle differential 66 is a device that divides the rotational power generated by the engine 4 between the axles of the tandem axle system 16 of the vehicle 2. As it can be by referencing FIG. 1 of the disclosure, the forward tandem axle system input shaft 64 drivingly connects the transfer case 12 to the inter-axle differential 66 of the forward tandem axle system 54 of the vehicle 2. In accordance with an embodiment of the disclosure and as a non-limiting example, the forward tandem axle system input shaft 64 is a drive shaft, a stub shaft, a coupling shaft, a forward tandem axle system input shaft, a pinion gear shaft or an inter-axle differential pinion gear shaft. The rotational power is transmitted through the forward tandem axle system 54 as described in more detail below.

As illustrated in FIG. 1 of the disclosure, the inter-axle differential 66 is drivingly connected to a forward tandem axle differential 68 and a forward tandem axle system output shaft 70. The forward tandem axle differential 68 is a set of gears that allows the outer drive wheel(s) of a wheeled vehicle 2 to rotate at a faster rate than the inner drive wheel(s).

The forward tandem axle system 54 of the vehicle 2 further includes the use of a first forward tandem axle half shaft 72 and a second forward tandem axle half shaft 74. The first forward tandem axle half shaft 72 extends substantially perpendicular to the forward tandem axle system input shaft 64. A first end portion 76 of the first forward tandem axle half shaft 72 is drivingly connected to a first forward tandem axle wheel assembly 78 and a second end portion 80 of the first forward tandem axle half shaft 72 is drivingly connected to a side of the forward tandem axle differential 68. As a non-limiting example, the second end portion 80 of the first forward tandem axle half shaft 72 is drivingly connected to a forward tandem axle differential side gear, a separate stub shaft, a separate coupling shaft, a first forward tandem axle differential output shaft, a first forward tandem axle half shaft disconnect system and/or a shaft that is formed as part of a forward tandem axle differential side gear.

Extending substantially perpendicular with the forward tandem axle system input shaft 64 is the second forward tandem axle half shaft 74 of the forward tandem axle system 54. A first end portion 82 of the second forward tandem axle half shaft 74 is drivingly connected to a second forward tandem axle wheel assembly 84. As illustrated in FIG. 1 of the disclosure, a second end portion 86 of the second forward tandem axle half shaft 74 is drivingly connected to a side of the forward tandem axle differential 68 opposite the first forward tandem axle half shaft 72. As a non-limiting example, the second end portion 86 of the second forward tandem axle half shaft 74 is drivingly connected to a forward tandem axle differential side gear, a separate stub shaft, a separate coupling shaft, a second forward tandem axle differential output shaft, a second forward tandem axle half shaft disconnect system and/or a shaft that is formed as part of a forward tandem axle differential side gear.

One end of the forward tandem axle system output shaft 70 is drivingly connected to a side of the inter-axle differential 66 opposite the forward tandem axle system input shaft 64. Drivingly connected to an end of the forward tandem axle system output shaft 70, opposite the inter-axle differential 66, is a fifth joint assembly 88. An end of the fifth joint assembly 88, opposite the forward tandem axle output shaft 70, is drivingly connected to a first end portion 90 of a third shaft 92. The third shaft 92 extends from the forward tandem axle system 54 toward a rear tandem axle system 94 of the tandem axle system 16 of the vehicle 2. As a non-limiting example, the third shaft 92 is a drive shaft, a prop shaft, a Cardan shaft, a double cardan shaft, a universal joint shaft or a universal coupling shaft. A second end portion 96 of the third shaft 92 is drivingly connected to a sixth joint assembly 98.

Drivingly connected to an end of the sixth joint assembly 98, opposite the third shaft 92, is a rear tandem axle system input shaft 100. An end of the rear tandem axle system input shaft 100, opposite the sixth joint assembly 98, is drivingly connected to a rear tandem axle differential 102 of the rear tandem axle system 94 of the vehicle 2. The rear tandem axle differential 102 is a set of gears that allows the outer drive wheel(s) of a wheeled vehicle 2 to rotate at a faster rate than the inner drive wheel(s). As it can be seen by referencing FIG. 1 of the disclosure, the rear tandem axle system input shaft 94 drivingly connects the inter-axle differential 66 to the rear tandem axle differential 102 of the rear tandem axle system 94 of the vehicle 2. The rotational power is transmitted through the rear tandem axle system 94 as described in more detail below.

The rear tandem axle system 94 further includes the use of a first rear tandem axle half shaft 104 and a second rear tandem axle half shaft 106. The first rear tandem axle half shaft 104 extends substantially perpendicular to the rear tandem axle system input shaft 100 of the rear tandem axle system 94 of the vehicle 2. A first end portion 108 of the first rear tandem axle half shaft 104 is drivingly connected to a first rear tandem axle wheel assembly 110 and a second end portion 112 of the first rear tandem axle half shaft 104 is drivingly connected to a side of the rear tandem axle differential 102. As a non-limiting example, the second end portion 112 of the first rear tandem axle half shaft 104 is drivingly connected to a rear tandem axle differential side gear, a separate stub shaft, a separate coupling shaft, a first rear tandem axle differential output shaft, a first rear tandem axle half shaft disconnect system and/or a shaft that is formed as part of a rear tandem axle differential side gear.

Extending substantially perpendicularly with the rear tandem axle system input shaft 100 is the second rear tandem axle half shaft 106. A first end portion 114 of the second rear tandem axle half shaft 106 is drivingly connected to a second rear tandem axle wheel assembly 116. As illustrated in FIG. 1 of the disclosure, a second end portion 118 of the second rear tandem axle half shaft 106 is drivingly connected to a side of the rear tandem axle differential 102 opposite the first rear tandem axle half shaft 104. As a non-limiting example, the second end portion 118 of the second rear tandem axle half shaft 106 is drivingly connected to a rear tandem axle differential side gear, a separate stub shaft, a separate coupling shaft, a second rear tandem axle differential output shaft, a second rear tandem axle half shaft disconnect system and/or a shaft that is formed as part of a rear tandem axle differential side gear.

According to an embodiment of the disclosure and as a non-limiting example, the joint assemblies 26, 30, 58, 62, 88 and/or 98 of the vehicle 2 may be a universal coupling, a U-joint, a cardan joint, a double cardan joint, a Spicer joint, a Hardy Spicer Joint or a Hooke's joint. Additionally, according to an embodiment of the disclosure and as a non-limiting example, the joint assemblies 30, 62 and/or 98 of the vehicle 2 may be a direct pinion mount constant velocity joint, a fixed direct pinion mount sliding ball type constant velocity joint, a direct pinion mount plunging cross groove sliding ball type constant velocity joint, a direct pinion mount double offset plunging constant velocity joint or a direct pinion mount tripod type constant velocity joint.

It is within the scope of this disclosure and as a non-limiting example that one or more of the differential assemblies 34, 66, 68, and/or 102 may be a differential assembly according to an embodiment of the disclosure. Additionally, it is within the scope of this disclosure and as a non-limiting example that the transfer case 12 may incorporate the use of a differential assembly according to an embodiment of the disclosure.

FIG. 2 is a schematic top-plan view of another vehicle 150 having one or more differential assemblies according to an embodiment of the disclosure. The vehicle 150 illustrated in FIG. 2 of the disclosure is the same as the vehicle 2 illustrated in FIG. 1, except where specifically noted below. As illustrated in FIG. 2 of the disclosure, the vehicle 150 does not include the transfer case 12. As a result, an end of the transmission output shaft 8, opposite the transmission 6, is drivingly connected to the end of the third joint assembly 58 opposite the second shaft 52.

In accordance with an embodiment of the disclosure and as a non-limiting example, one or more of the differential assemblies 66, 68 and/or 102 of the vehicle 150 may be a differential assembly according to an embodiment of the disclosure.

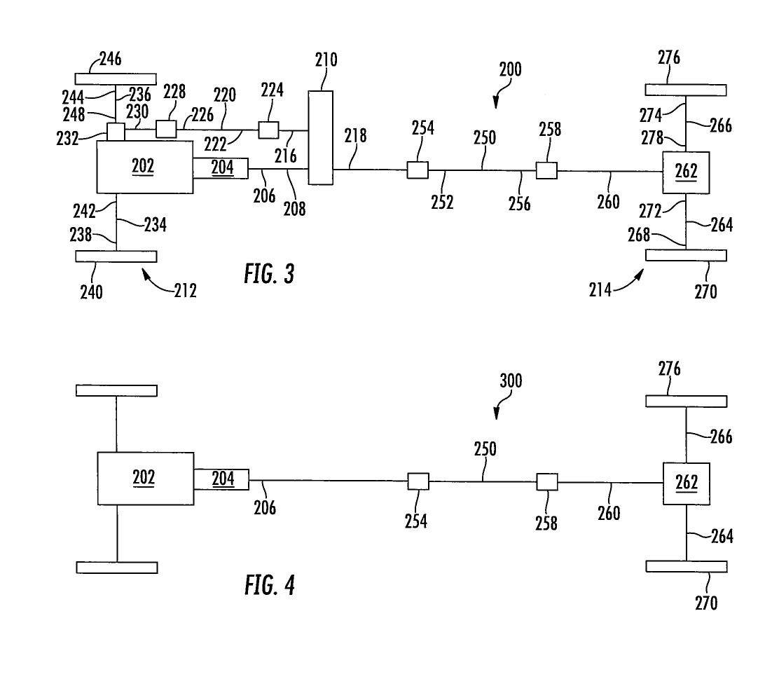

FIG. 3 is a schematic top-plan view of yet another vehicle 200 having one or more differential assemblies according to an embodiment of the disclosure. The vehicle 200 has an engine 202 which is drivingly connected to a transmission 204. As non-limiting example, the engine 202 of the vehicle 200 may be an internal combustion engine, an external combustion engine, an electric motor, a steam turbine and/or a gas turbine. A transmission output shaft 206 is then drivingly connected to an end of the transmission 204 opposite the engine 202. The transmission 204 is a power management system which provides controlled application of the rotational energy generated by the engine 202 by means of a gearbox.

An end of the transmission output shaft 206, opposite the transmission 204, is drivingly connected to a transfer case input shaft 208 which in turn is drivingly connected to a transfer case 210. The transfer case 210 is used in four-wheel drive and/or all-wheel-drive (AWD) vehicles to transfer the rotational power from the transmission 204 to a forward axle system 212 and a rear axle system 214 by utilizing a series of gears and drive shafts. The transfer case 210 additionally allows the vehicle 200 to selectively operate in either a two-wheel drive mode of a four-wheel/AWD mode. The transfer case 212 includes a first transfer case output shaft 216 and a second transfer case output shaft 218.

A first shaft 220 extends from the first transfer case output shaft 216 to the front axle system 212 thereby drivingly connecting the transfer case 210 to the front axle system 212 of the vehicle 200. In accordance with an embodiment of the disclosure and as a non-limiting example, the first shaft 220 is a drive shaft, a prop shaft, a Cardan shaft, a double cardan shaft, a universal joint shaft or a universal coupling shaft. A first end portion 222 of the first shaft 220 is drivingly connected to an end of the first transfer case output shaft 216, opposite the transfer case 210, via a first joint assembly 224. As illustrated in FIG. 3 of the disclosure, a second end portion 226 of the first shaft 220 is drivingly connected to a second joint assembly 228.

Drivingly connected to an end of the second joint assembly 228, opposite the first shaft 220, is a front axle input shaft 230. As a non-limiting example, the front axle input shaft 230 is a front differential input shaft, a coupling shaft, stub shaft or a front differential pinion shaft. Drivingly connected to an end of the front axle input shaft 230, opposite the first shaft 220, is a front axle differential 232 of the front axle system 212 of the vehicle 200. The front axle differential 232 is a set of gears that allows the outer drive wheel(s) of the wheeled vehicle 200 to rotate at a faster rate that the inner drive wheel(s). The rotational power is transmitted through the front axle system 212 as described in more detail below.

The front axle system 212 further includes a first front axle half shaft 234 and a second front axle half shaft 236. The first front axle half shaft 234 extends substantially perpendicular to the front axle input shaft 230 of the front axle system 212. A first end portion 238 of the first front axle half shaft 234 is drivingly connected to a first front axle wheel assembly 240 and a second end portion 242 of the first front axle half shaft 234 is drivingly connected to a side of the front axle differential 232. As a non-limiting example, the second end portion 242 of the first front axle half shaft 234 is drivingly connected to a front differential side gear, a separate stub shaft, a separate coupling shaft, a first front axle differential output shaft, a first front axle half shaft disconnect system and/or a shaft that is formed as part of a front differential side gear.

Extending substantially perpendicular to the front axle system input shaft 230 is the second front axle half shaft 236. A first end portion 244 of the second front axle half shaft 236 is drivingly connected to a second front axle wheel assembly 246 and a second end portion 248 of the second front axle half shaft 236 is drivingly connected to a side of the front axle differential 232 opposite the first front axle half shaft 234. As a non-limiting example, the second end portion 248 of the second front axle half shaft 236 is drivingly connected to a front differential side gear, a separate stub shaft, a separate coupling shaft, a second front axle differential output shaft, a second front axle half shaft disconnect system and/or a shaft that is formed as part of a front differential side gear.

An end of the second transfer case output shaft 218 is drivingly connected to an end of the transfer case 210 opposite the transfer case input shaft 208. A second shaft 250 extends from the second transfer case output shaft 218 toward the rear axle system 214 of the vehicle 200. In accordance with an embodiment of the disclosure and as a non-limiting example, the second shaft 250 is a drive shaft, a prop shaft, a Cardan shaft, a double cardan shaft, a universal joint shaft or a universal coupling shaft. A first end portion 252 of the second shaft 250 is drivingly connected to an end of the second transfer case output shaft 218, opposite the transfer case 210, via a third joint assembly 254. As illustrated in FIG. 3 of the disclosure, a second end portion 256 of the second shaft 250 is drivingly connected to a fourth joint assembly 258.

Drivingly connected to an end of the fourth joint assembly 258, opposite the second shaft 250, is a rear axle system input shaft 260. An end of the rear axle system input shaft 268, opposite the fourth joint assembly 258, is drivingly connected to a rear axle differential 262 of the rear axle system 214 of the vehicle 200. The rear axle differential 262 is a set of gears that allows the outer drive wheel(s) of a wheeled vehicle 200 to rotate at a faster rate than the inner drive wheel(s). As it can be by referencing FIG. 3 of the disclosure, the rear axle system input shaft 260 drivingly connects the transfer case 210 to the rear axle differential 262 of the rear axle system 214 of the vehicle 200. In accordance with an embodiment of the disclosure and as a non-limiting example, the rear axle system input shaft 260 is a drive shaft, a stub shaft, a coupling shaft, a rear axle system input shaft, a pinion gear shaft, a rear axle differential pinion gear shaft and/or a rear axle differential input shaft. The rotational power is transmitted through the rear tandem axle system 214 as described in more detail below.

The rear axle system 214 further includes the use of a first rear axle half shaft 264 and a second rear axle half shaft 266. The first rear axle half shaft 264 extends substantially perpendicular to the rear axle system input shaft 260. A first end portion 268 of the first rear axle half shaft 264 is drivingly connected to a first rear axle wheel assembly 270 and a second end portion 272 of the first rear axle half shaft 264 is drivingly connected to a side of the rear axle differential 262. As a non-limiting example, the second end portion 272 of the first rear axle half shaft 264 is drivingly connected to a rear axle differential side gear, a separate stub shaft, a separate coupling shaft, a first rear axle differential output shaft, a first rear axle half shaft disconnect system and/or a shaft that is formed as part of a rear axle differential side gear.

Extending substantially perpendicular with the rear axle system input shaft 260 is the second rear axle half shaft 266. A first end portion 274 of the second rear axle half shaft 266 is drivingly connected to a second rear axle wheel assembly 276. As illustrated in FIG. 3 of the disclosure, a second end portion 278 of the second rear axle half shaft 266 is drivingly connected to a side of the rear axle differential 262 opposite the first rear axle half shaft 264. As a non-limiting example, the second end portion 278 of the second rear axle half shaft 266 is drivingly connected to a rear axle differential side gear, a separate stub shaft, a separate coupling shaft, a second rear axle differential output shaft, a second rear axle half shaft disconnect system and/or a shaft that is formed as part of a rear axle differential side gear.

According to an embodiment of the disclosure and as a non-limiting example, the joint assemblies 224, 228, 254 and/or 258 of the vehicle 200 may be a universal coupling, a U-joint, a cardan joint, a double cardan joint, a Spicer joint, a Hardy Spicer Joint or a Hooke's joint. Additionally, according to an embodiment of the disclosure and as a non-limiting example, the joint assemblies 228 and/or 258 of the vehicle 200 may be a direct pinion mount constant velocity joint, a fixed direct pinion mount sliding ball type constant velocity joint, a direct pinion mount plunging cross groove sliding ball type constant velocity joint, a direct pinion mount double offset plunging constant velocity joint or a direct pinion mount tripod type constant velocity joint.

It is within the scope of this disclosure that one or more of the differential assemblies 232 and/or 262 of the vehicle 200 may be a differential assembly according to an embodiment of the disclosure. Additionally, it is within the scope of this disclosure and as a non-limiting example that the transfer case 210 may incorporate the use of a differential assembly according to an embodiment of the disclosure.

FIG. 4 is a schematic top-plan view of still yet another vehicle 300 having one or more differential assemblies according to an embodiment of the disclosure. The vehicle 300 illustrated in FIG. 4 of the disclosure is the same as the vehicle 200 illustrated in FIG. 3, except where specifically noted below. As illustrated in FIG. 4 of the disclosure, the vehicle 300 does not include the transfer case 210. As a result, an end of the transmission output shaft 208, opposite the transmission 204, is drivingly connected to the end of the third joint assembly 254 opposite the second shaft 250.

In accordance with an embodiment of the disclosure and as a non-limiting example, the differential assembly 262 of the vehicle 300 may be a differential assembly according to an embodiment of the disclosure.

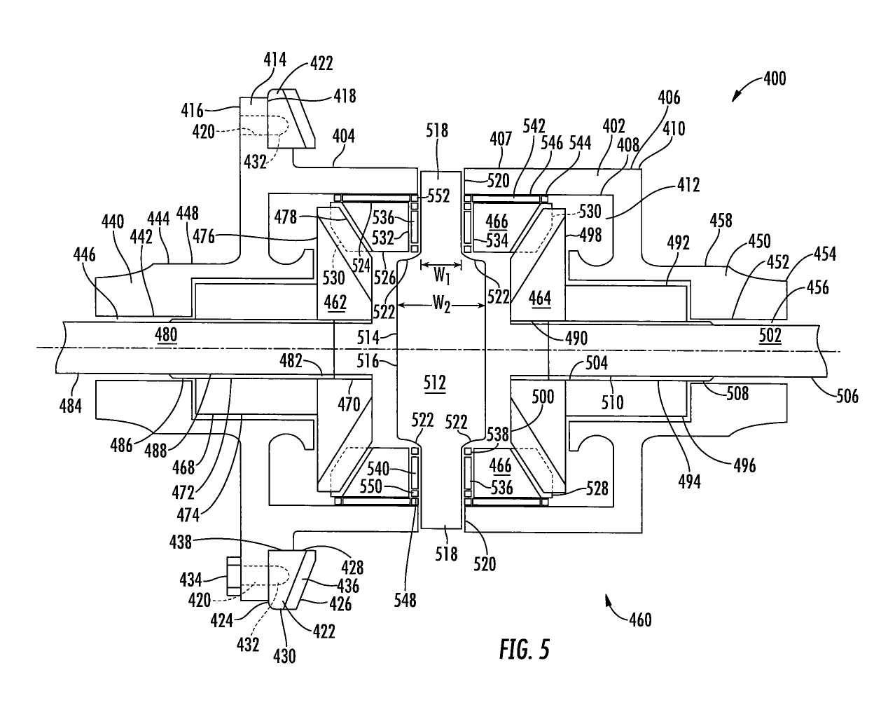

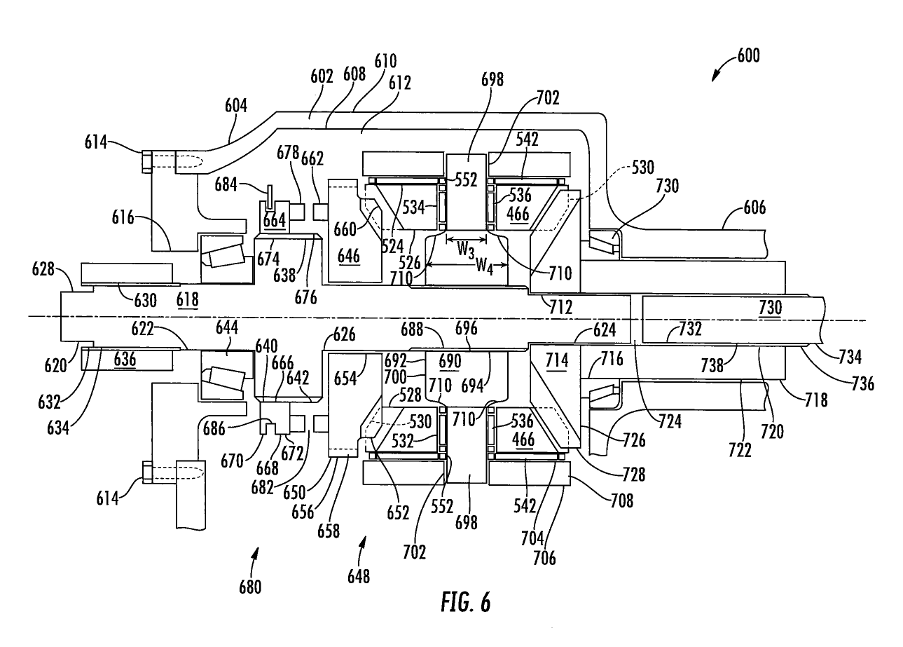

FIG. 5 is a cut-away schematic side-view of a portion of a differential assembly 400 according to an embodiment of the disclosure. As illustrated in FIG. 5 f the disclosure, the axle system 400 includes a differential assembly 402 having a differential gear set 404. It is within the scope of this disclosure and as a non-limiting example that the axle system 400 may be a front axle system, a rear axle system, a forward tandem axle system and/or a rear tandem axle system. Additionally, it is within the scope of this disclosure and as a non-limiting example that the differential assembly 400 may be used within a transfer case of a vehicle.

As illustrated in FIG. 5 of the disclosure, the differential assembly has a differential case 402 having a first end portion 404, a second end portion 406, an intermediate portion 407, an inner surface 408 and an outer surface 410. The inner surface 408 and the outer surface 410 of the differential case 402 defines a hollow portion 412 therein. In accordance with an embodiment of the disclosure and as a non-limiting example, the differential case 402 may be made be made of a single integrally formed component or made of a plurality of components that are integrally connected to one another to form the differential case 402 described herein.

Circumferentially extending from at least a portion of the outer surface 410 of the first end portion 404 of the differential case 402 is a first increased diameter portion 414 having a first side 416 and a second side 418. Extending from the first side 416 to the second side 418 of the first increased dimeter portion 414 of the differential case 402 is one or more first increased diameter portion attachment apertures 420.

Integrally connected to at least a portion of the first increased diameter portion 414 of the differential case 402 is an input gear 422 having a first side 424, a second side 426, an inner surface 428 and an outer surface 430. According to the embodiment of the disclosure illustrated in FIG. 5 and as a non-limiting example, at least a portion of the first side 424 of the input gear 422 is directly adjacent to at least a portion of the second side 418 of the first increased diameter portion 414 of the differential case 402. It is within the scope of this disclosure and as a non-limiting example that the input gear 422 may be a differential ring gear.

Extending inward from at least a portion of the first side 424 of the input gear 422 is one or more input gear attachment portions 432. The one or more attachment portions 432 of the input gear 422 are complementary to and aligned with the one or more first increased diameter portion attachment apertures 420 in the first increased diameter portion 414 of the differential case 402. In accordance with the embodiment illustrated in FIG. 5 of the disclosure and as a non-limiting example, the one or more first increased diameter portion attachment apertures 420 and the one or more input gear attachment portions 432 are of a size and shape to receive and/or retain at least a portion of one or more mechanical fasteners 434. As a non-limiting example, the one or more mechanical fasteners 434 are one or more bolts.

According to an embodiment of the disclosure (not shown) and as a non-limiting example, the input gear 422 of the differential assembly 400 may be integrally connected to at least a portion of the first increased diameter portion 414 of the differential case 402 by using one or more welds. In accordance with an alternative embodiment of the disclosure (not shown) and as a non-limiting example, the input gear 422 may be integrally formed as part of the first increased diameter portion 414 of the differential case 402 of the differential assembly 400.

Circumferentially extending from at least a portion of the outer surface 430 of the input gear 422 is a plurality of input gear teeth 436. In accordance with the embodiment of the disclosure illustrated in FIG. 5 and as a non-limiting example, the plurality of input gear teeth 436 circumferentially extend from at least a portion of the outer surface 430 of the second side 426 of the input gear 422. The plurality of input gear teeth are complementary to and meshingly engaged with a plurality of pinion gear teeth (not shown) circumferentially extending from at least a portion of an outer surface of a pinion gear (not shown).

According to an embodiment of the disclosure and as a non-limiting example, at least a portion of the inner surface 428 of the input gear 422 is in direct contact with at least a portion of a second increased diameter portion 438. In accordance with this embodiment of the disclosure and as a non-limiting example, the second increased diameter portion 438 of the differential case circumferentially extends from at least a portion of the outer surface 410 of the differential case 402. Additionally, in accordance with this embodiment of the disclosure and as a non-limiting example, the second increased diameter portion 438 of the differential case 402 is disposed directly adjacent to at least a portion of the second side 418 of the first increased diameter portion 414 of the differential case 402. It is within the scope of this disclosure and as a non-limiting example that the second increased diameter portion 438 of the differential case may have a diameter that is less than a diameter of the first increased diameter portion 414 of the differential case 402.

Extending outboard from at least portion of the first end portion 404 of the differential case 402 is a first axially extending portion 440 having an inner surface 442 and an outer surface 444 defining a hollow portion 446 therein. As illustrated in FIG. 5 of the disclosure, at least a portion of the first axially extending portion 440 of the differential case 402 extends in a direction axially away from the first increased diameter portion 414 of the differential case 402. It is within the scope of this disclosure and as a non-limiting example that at least a portion of the outer surface 444 of the first axially extending portion 440 of the differential case 402 may provide a bearing surface 448 for one or more first differential case bearings (not shown). The one or more first differential case bearings (not shown) of the differential assembly 400 provide rotational support for at least a portion of the first end portion 404 of the differential case 402 when in operation.

Extending outboard from at least a portion of the second end portion 406 of the differential case is a second axially extending portion 450 having an inner surface 452 and an outer surface 454 defining a hollow portion 456 therein. As illustrated in FIG. 5 of the disclosure, at least a portion of the second axially extending portion 450 of the differential case 402 extends axially in a direction away from the first increased diameter portion 414 of the differential case 402. It is within the scope of this disclosure and as a non-limiting example that at least a portion of the outer surface 454 of the second axially extending portion 450 of the differential case 402 may provide a bearing surface 458 for one or more second differential case bearings (not shown). The one or more second differential case bearings (not shown) of the differential assembly 400 provide rotational support for at least a portion of the second end portion 406 of the differential case 402 when in operation.

As illustrated in FIG. 5 of the disclosure, the hollow portion 412 of the differential case 402 is of a size and shape to receive and/or retain at least a portion of a differential gear set 460. It is within the scope of this disclosure and as a non-limiting example, that the differential gear set 460 of the differential assembly 400 may include a first side gear 462, a second side gear 464 and one or more pinion gears 466. In accordance with the embodiment of the disclosure illustrated in FIG. 5 and as a non-limiting example, the first side gear 462 of the differential assembly 400 has a first end portion 468, a second end portion 470 an inner surface 472 and an outer surface 474. As illustrated in FIG. 5 of the disclosure, at least a portion of the first side gear 462 of the differential gear set 460 extends from the hollow portion 412 of the differential case 402 into at least a portion of the hollow portion 446 of the first axially extending portion 440 of the differential case 402.

Circumferentially extending form at least a portion of the outer surface 474 of the first side gear 462 of the differential assembly 400 is an increased diameter portion 476. As illustrated in FIG. 5 of the disclosure, a plurality of first side gear teeth 478 circumferentially extend from at least a portion of the outer surface 474 of the increased diameter portion 476 of the first side gear 462 of the differential gear set 460.

Extending co-axially with and drivingly connected to at least a portion of the first side gear 462 of the differential assembly 400 is a first shaft 480 having a first end portion (not shown), a second end portion 482 and an outer surface 484. Circumferentially extending along at least a portion of the outer surface 484 of the first shaft 480 is a plurality of axially extending first shaft splines 486. The plurality of axially extending first shaft splines 486 are complementary to and meshingly engaged with a plurality of axially extending first side gear splines 488 circumferentially extending along at least a portion of the inner surface 472 of the first side gear 462. It is within the scope of this disclosure and as a non-limiting example that the first shaft 480 may be a coupling shaft, a stub shaft, a first output shaft, a first differential output shaft, a first front axle half shaft, a first rear axle half shaft, a first forward tandem axle half shaft and/or a first rear tandem axle half shaft.

As illustrated in FIG. 5 of the disclosure and as a non-limiting example, the second side gear 464 has a first end portion 490, a second end portion 492, an inner surface 494 and an outer surface 496. In accordance with the embodiment of the disclosure illustrated in FIG. 5 and as a non-limiting example, at least a portion of the second end portion 492 of the second side gear 464 extends from the hollow portion 412 of the differential case 402 into at least a portion of the hollow portion 456 of the second axially extending portion 450 of the differential case 402.

Circumferentially extending form at least a portion of the outer surface 496 of the second side gear 464 of the differential assembly 400 is an increased diameter portion 498. As illustrated in FIG. 5 of the disclosure, a plurality of second side gear teeth 500 circumferentially extend from at least a portion of the outer surface 496 of the increased diameter portion 498 of the second side gear 464 of the differential gear set 460.

Extending co-axially with and drivingly connected to at least a portion of the second side gear 464 of the differential assembly 400 is a second shaft 502 having a first end portion 504, a second end portion (not shown) and an outer surface 506. Circumferentially extending along at least a portion of the outer surface 506 of the second shaft 502 is a plurality of axially extending second shaft splines 508. The plurality of axially extending second shaft splines 508 are complementary to and meshingly engaged with a plurality of axially extending second side gear splines 510 circumferentially extending along at least a portion of the inner surface 494 of the second side gear 464. It is within the scope of this disclosure and as a non-limiting example that the second shaft 502 may be a coupling shaft, a stub shaft, a second output shaft, a second differential output shaft, a second front axle half shaft, a second rear axle half shaft, a second forward tandem axle half shaft and/or a second rear tandem axle half shaft.

Interposed between the first and second side gears 462 and 464 of the differential gear assembly 460 is one or more spiders 512 having a body portion 514. Extending outboard from at least a portion of an outer surface 516 of the body portion 514 of the one or more spiders 512 is one or more trunnions 518. The one or more trunnions 518 extend from the outer surface 516 of the body portion 514 of the one or more spiders 512 into one or more spider apertures 520 extending from the inner surface 408 to the outer surface 410 of the intermediate portion 407 of the differential case 402. The one or more spider apertures 520 are of a size and shape to receive and/or retain at least a portion of the one or more trunnions 518 of the one or more spiders 512 of the differential assembly 400. In accordance with an embodiment of the disclosure and as a non-limiting example, the one or more trunnions 518 of the one or more spiders 512 are substantially cylindrical in shape.

According to the embodiment of the disclosure illustrated in FIG. 5 and as a non-limiting example, the one or more trunnions 518 extending from the body portion 514 of the one or more spiders 512 have a width W1 that is less than a width W2 of the body portion 514 of the one or more spiders 512. In accordance with this embodiment of the disclosure, the one or more spiders 512 includes one or more shoulder portions 522 connecting the body portion 514 of the one or more spiders 512 to the one or more trunnions 518 of the one or more spiders 512.

The one or more pinion gears 466 have a radially outboard surface 524, a radially inboard surface 526 and an outer surface 528. Circumferentially extending from at least a portion of the outer surface 528 of the one or more pinion gears 466 of the differential gear set 466 is a plurality of pinion gear teeth 530. As illustrated in FIG. 5 of the disclosure, the plurality of pinion gear teeth 530 are complementary to and meshingly engaged with the plurality of first side gear teeth 478 on the outer surface 475 of the first side gear 462 and the plurality of second side gear teeth 500 on the outer surface 496 of the second side gear 464. In accordance with the embodiment of the disclosure illustrated in FIG. 5 and as a non-limiting example, the radially outboard surface 524 and/or the radially inboard surface 526 of the one or more pinion gears 466 are substantially flat.

Extending from the radially outboard surface 524 to the radially inboard surface 526 of the one or more spider gears 466 is one or more pinion gear apertures 532. The one or more pinion gear apertures 532 have a size and shape to receive and/or retain at least a portion of the one or more trunnions 518 of the one or more spiders 512 of the differential assembly 400.

Interposed between the outer surface 516 of the one or more trunnions 518 of the one or more spiders 512 and a surface 534 defining the one or more pinion gear apertures 532 in the one or more pinion gears 466 is one or more first bearing assemblies 536. According to an embodiment of the disclosure and as a non-limiting example, the one or more first mearing assemblies 536 may have a size and shape such that the one or more first bearing assemblies 536 are press-fit around the outer surface 516 of the one or more trunnions 518 of the one or more spiders 512. In accordance with an alternative embodiment of the disclosure and as a non-limiting example, the one or more first bearing assemblies 536 may have a size and shape such that the one or more first bearing assemblies 536 are press-fit within the surface 534 defining the one or more pinion gear apertures 532 in the one or more pinion gears 466. It is within the scope of this disclosure and as a non-limiting example that the one or more first bearing assemblies 536 may be substantially cylindrical in shape. Additionally, it is within the scope of this disclosure and as a non-limiting example that the one or more first bearing assemblies 536 may be one or more needle bearing assemblies.

According to the embodiment illustrated in FIG. 5 of the disclosure and as a non-limiting example, the one or more first bearing assemblies 536 have a body portion 538 having a size and shape to receive and/or retain at least a portion of one or more rolling elements 540 therein. When assembled, at least a portion of the one or more rolling elements 540 of the one or more first bearing assemblies 536 are in direct contact with at least a portion of the surface 534 defining the one or more pinion gear apertures 532 and/or are in direct contact with at least a portion of the outer surface 516 of the one or more trunnions 518. The one or more first bearing assemblies 536 reduce the overall amount of friction between the one or more pinion gears 466 and the one or more trunnions 518 of the one or more spiders 512 when in operation. As a result, the one or more first bearing assemblies 536 of the differential assembly 400 aid in reducing the occurrence of and/or prevent the occurrence of a spin-out failure within the differential assembly 400 of the vehicle (not shown).

In accordance with an alternative embodiment of the disclosure (not shown) and as a non-limiting example, the differential assembly 400 may include one or more bearing assemblies 536 that are stacked on top of each other. According to this embodiment of the disclosure (not shown), at least a portion of the one or more bearing assemblies 536 stacked on top of each other are interposed between the surface 534 defining the one or more pinion gear apertures 532 in the one or more pinion gears 466 and the outer surface 516 of the one or more trunnions 518 of the one or more spiders 512.

It is within the scope of this disclosure that the one or more shoulder portions 520 of the one or more spiders 512 may provide rotational support for at least a portion of the one or more pinion gears 466 and the one or more first bearing assemblies 536 of the differential assembly 400.

In accordance with the embodiment illustrated in FIG. 5 of the disclosure and as a non-limiting example, the differential assembly 400 may also include the use of one or more second bearing assemblies 542. As illustrated in FIG. 5 of the disclosure, the one or more second bearing assemblies 542 are interposed between the radially outboard surface 524 of the one or more pinion gears 466 and the inner surface 408 of the differential case 402 of the differential assembly 400. According to an embodiment of the disclosure and as a non-limiting example, the one or more second bearing assemblies 542 may have a size and shape to aid in retaining the one or more first bearing assemblies 536 between the outer surface 516 of the one or more trunnions 518 and a surface 534 defining the one or more pinion gear apertures 532 in the one or more pinion gears 466. It is within the scope of this disclosure and as a non-limiting example that the one or more second bearing assemblies 542 may be a needle bearing assembly.

According to the embodiment illustrated in FIG. 5 of the disclosure and as a non-limiting example, the one or more second bearing assemblies 542 have a body portion 544 having a size and shape to receive and/or retain at least a portion of one or more rolling elements 546 therein. When assembled, at least a portion of the one or more rolling elements 546 of the one or more second bearing assemblies 542 are in direct contact with at least a portion of the inner surface 408 of the differential case 402 and/or are in direct contact with at least a portion of the radially outboard surface 524 of the one or more pinion gears 466. The one or more second bearing assemblies 542 reduce the overall amount of friction between the one or more pinion gears 466 and inner surface 408 of the differential case 402 when in operation. As a result, the one or more second bearing assemblies 542 of the differential assembly 400 aid in reducing the occurrence of and/or prevent the occurrence of a spin-out failure within the differential assembly 400 of the vehicle (not shown).

Extending from a radially outboard surface 548 to a radially inboard surface 550 of the body portion 544 of the one or more second bearing assemblies 542 is a spider trunnion aperture 552. The spider trunnion aperture 552 in the body portion 544 of the one or more second bearing assemblies 542 is of a size and shape to receive and/or retain at least a portion of the one or more trunnions 518 of the one or more spiders 512 of the differential assembly 400. In accordance with the embodiment of the disclosure illustrated in FIG. 5 and as a non-limiting example, the one or more second bearing assemblies are substantially disk-shaped.

It is within the scope of this disclosure and as a non-limiting example that the differential assembly 400 may include the use of one or more first bearing spacers (not shown) interposed between the one or more first bearing assemblies 536 and the shoulder portion 522 of the one or more spiders 512. Additionally, it is within the scope of this disclosure and as a non-limiting example that the differential assembly 400 may include one or more second bearing spacers (not shown) interposed between the one or more first bearing assemblies 536 and the one or more second bearing assemblies 542 of the differential assembly 400. The one or more first and second bearing spacers (not shown) may be used to aid in the assembly of the differential assembly 400, provide rotational support and/or reduce the overall amount of friction between the one or more first and second bearing assemblies 536 and 542 when in operation.

FIG. 6 is a cut-away schematic side view of a portion of a differential assembly 600 according to an alternative embodiment of the disclosure. The differential assembly 600 illustrated in FIG. 6 is the same as the differential assembly 400 illustrated in FIG. 5 of the disclosure, except where specifically noted below. As illustrated in FIG. 6 of the disclosure, the differential assembly 600 includes an axle housing 602 having a first end portion 604, a second end portion 606, an inner surface 608 and an outer surface 610. The inner surface 608 and the outer surface 610 of the axle housing 602 defines a hollow portion 612 therein. According to an embodiment of the disclosure and as a non-limiting example, the axle housing 602 may be made of a single integrally formed component or made of a plurality of components that are integrally connected to one another to form the axle housing 602 described herein. In accordance with the embodiment of the disclosure where the axle housing 602 is made of a plurality of components and as a non-limiting example, the plurality of components of the axle housing 602 may be integrally connected to one another by using one or more mechanical fasteners 614. As a non-limiting example, the housing 602 may be a tandem axle housing such as but not limited to a forward tandem axle housing.

Extending from outside the axle housing 602 through an opening 616 extending from the inner surface 608 to the outer surface 610 of the first end portion 604 of the axle housing 602 is an input shaft 618. As illustrated in FIG. 6 of the disclosure, the input shaft 618 has an outer surface 620, a first end portion 622, a second end portion 624 and an intermediate portion 626 interposed between the first and second end portions 622 and 624 of the input shaft 618. At least a portion of the first end portion 622 of the input shaft 618 of the differential assembly 600 is a reduced diameter portion 628. In accordance with the embodiment of the disclosure illustrated in FIG. 6 and as a non-limiting example, at least a portion of the first reduced diameter portion 628 of the input shaft 618 is disposed outside of the axle housing 602.

Circumferentially extending along at least a portion of the outer surface 620 of the first end portion 622 of the input shaft 618 is a first plurality of axially extending input shaft splines 630. The first plurality of axially extending input shaft splines 630 are complementary to and meshingly engaged with a plurality of axially extending shaft splines 632 circumferentially extending from at least a portion of an inner surface 634 of a shaft 636. It is within the scope of this disclosure and as a non-limiting example, that the shaft 636 may be a stub shaft, a coupling shaft, an axle system input shaft, a forward tandem axle system input shaft, a propeller shaft and/or a drive shaft.

An increased diameter portion 638 having a first end portion 640 and a second end portion 642 circumferentially extends from at least a portion of the outer surface 620 of the intermediate portion 626 of the input shaft 618.

Disposed directly adjacent to at least a portion of the first end portion 640 of the increased diameter portion 638 of the input shaft 618 is a first tapered roller bearing assembly 644. As illustrated in FIG. 6 of the disclosure and as a non-limiting example, at least a portion of the first tapered roller bearing assembly 644 is interposed between the inner surface 608 of the axle housing 602 and the outer surface 620 of the input shaft 618 of the differential assembly 600. The first tapered roller bearing 644 provides rotational support for at least a portion of the input shaft 618 when in operation.

Disposed directly adjacent to at least a portion of the second end portion 642 of the increased diameter portion 638 of the input shaft 618 of the differential assembly 600 is a first side gear 646 of a differential gear set 648. As illustrated in FIG. 6 of the disclosure and as a non-limiting example, the first side gear 646 extends co-axially with the input shaft 618 and has a first end portion 650, a second end portion 652, an inner surface 654 and an outer surface 656. In accordance with an embodiment of the disclosure and as a non-limiting example, the first side gear 646 of the differential gear set 648 of the differential assembly 600 is an input helical side gear.

Circumferentially extending from at least a portion of the outer surface 656 of the first side gear 646 is a first plurality of input helical side gear teeth 658. The first plurality of input helical side gear teeth 658 are complementary to and meshingly engaged with a plurality of intermediate gear teeth (not shown) circumferentially extending from at least a portion of an outer surface of an intermediate gear (not shown).

A second plurality of input helical side gear teeth 660 circumferentially extend from at least a portion of the second end portion 652 of the first side gear 646 of the differential gear set 648 of the differential assembly 600. The second plurality of input helical side gear teeth 660 are complementary to and meshingly engaged with the plurality of pinion gear teeth 530 circumferentially extending from at least a portion of the outer surface 528 of the one or more pinion gears 466 of the differential gear set 648.

According to an embodiment of the disclosure and as a non-limiting example, the first side gear 646 of the differential gear set 648 may additionally include a plurality of input helical side gear clutch teeth 662. The plurality of input helical side gear clutch teeth 662 circumferentially extend from at least a portion of the outer surface 656 of the first end portion 650 of the first side gear 646 of the differential gear set 648.

In accordance with the embodiment of the disclosure where the input helical side gear includes a plurality of input helical side gear clutch teeth 662, the differential assembly 600 may further include the use of a sliding collar 664 having an inner surface 666, an outer surface 668, a first end portion 670 and a second end portion 672. Circumferentially extending along at least a portion of the inner surface 666 of the sliding collar 664 is a plurality of axially extending sliding collar splines 674. The plurality of axially extending sliding collar splines 647 are complementary to and meshingly engaged with a second plurality of axially extending input shaft splines 676 circumferentially extending along at least a portion of the outer surface 620 of the increased diameter portion 638 of the input shaft 618.

A plurality of sliding collar clutch teeth 678 circumferentially extend from at least a portion of the outer surface 668 of the second end portion 672 of the sliding collar 664 of the differential assembly 600. The plurality of sliding collar clutch teeth 678 are complementary to and selectively engageable with the plurality of input helical side gear clutch teeth 662 on the first end portion 650 of the first side gear 646. When the sliding collar 664 is in the first disengaged 680 position illustrated in FIG. 6 the sliding collar 664 not engaged with the first side gear 646. As a result, the plurality of sliding collar clutch teeth 678 are not meshingly engaged with the plurality of input helical side gear clutch teeth 662 defining a gap 682 therebetween.

In order to translate the sliding collar 664 to a second engaged position (not shown), an end of a shift fork 684 is drivingly connected to at least a portion of the outer surface 668 of the sliding collar 664. According to the embodiment illustrated in FIG. 6 of the disclosure and as a non-limiting example, at least a portion of the shift fork 684 is disposed within a groove 686 circumferentially extending along at least a portion of the outer surface 668 of the sliding collar 664. At least a portion of the end of the shift fork 684, opposite the sliding collar 664, is drivingly connected to an actuation assembly (not shown). It is within the scope of this disclosure that the actuation assembly (not shown) may be a linear actuator assembly, a pneumatic actuator assembly and/or an electromechanical actuator assembly.

Disposed adjacent to the second end portion 672 of the first side gear 646 is a third plurality of axially extending input shaft splines 688. As illustrated in FIG. 6 of the disclosure, the third plurality of axially extending input shaft splines 688 circumferentially extend from at least a portion of the outer surface 620 of the input shaft 618 of the differential assembly 600.

Extending co-axially with and drivingly connected to the input shaft 618 is one or more spiders 690 having a body portion 692. Circumferentially extending from at least a portion of an inner surface 694 of the body portion 692 of the one or more spiders 690 is a plurality of axially extending spider splined 696. The plurality of axially extending spider splines 696 are complementary to and meshingly engaged with the third plurality of input shaft splines 688 on the outer surface 620 of the input shaft 618.

One or more trunnions 698 extend outboard from at least a portion of an outer surface 700 of the body portion 692 of the one or more spiders 690 of the differential assembly 600.

The one or more trunnions 986 extend from the outer surface 700 of the body portion 692 of the one or more spiders 690 through the one or more pinion gear apertures 530 in the one or more pinion gears 466 and into one or more spider apertures 702 within a differential case 708 of the differential assembly 600. As illustrated in FIG. 6 of the disclosure and as a non-limiting example, the one or more spider apertures 702 in the differential case 708 extend from an inner surface 704 to an outer surface 706 of the differential case 708. Additionally, as illustrated in FIG. 6 of the disclosure and as a non-limiting example, the one or more spider apertures 702 and/or the one or more pinion gear apertures 530 are of a size and shape to receive and/or retain at least a portion of the one or more trunnions 698 of the one or more spiders 690. In accordance with an embodiment of the disclosure and as a non-limiting example, the one or more trunnions 698 of the one or more spiders 690 are substantially cylindrical in shape.

According to the embodiment of the disclosure illustrated in FIG. 6 and as a non-limiting example, the one or more trunnions 698 extending from the body portion 692 of the one or more spiders 690 have a width W3 that is less than a width W4 of the body portion 692 of the one or more spiders 690. In accordance with this embodiment of the disclosure, the one or more spiders 690 includes one or more shoulder portions 710 connecting the body portion 692 of the one or more spiders 690 to the one or more trunnions 698 of the one or more spiders 690.

Interposed between the outer surface 700 of the one or more trunnions 698 of the one or more spiders 690 and the surface 534 defining the one or more pinion gear apertures 532 in the one or more pinion gears 466 is the one or more first bearing assemblies 536. According to an embodiment of the disclosure and as a non-limiting example, the one or more first mearing assemblies 536 may have a size and shape such that the one or more first bearing assemblies 536 are press-fit around the outer surface 700 of the one or more trunnions 698 of the one or more spiders 690. In accordance with an alternative embodiment of the disclosure and as a non-limiting example, the one or more first bearing assemblies 536 may have a size and shape such that the one or more first bearing assemblies 536 are press-fit within the surface 534 defining the one or more pinion gear apertures 532 in the one or more pinion gears 466.

When assembled, at least a portion of the one or more rolling elements 540 of the one or more first bearing assemblies 536 are in direct contact with at least a portion of the surface 534 defining the one or more pinion gear apertures 532 and/or are in direct contact with at least a portion of the outer surface 700 of the one or more trunnions 698. The one or more first bearing assemblies 536 reduce the overall amount of friction between the one or more pinion gears 466 and the one or more trunnions 698 of the one or more spiders 690 when in operation. As a result, the one or more first bearing assemblies 536 of the differential assembly 600 aid in reducing the occurrence of and/or prevent the occurrence of a spin-out failure within the differential assembly 600 of the vehicle (not shown).

According to an alternative embodiment of the disclosure (not shown) and as a non-limiting example, the differential assembly 600 may include one or more bearing assemblies 536 that are stacked on top of each other. In accordance with this embodiment of the disclosure (not shown), at least a portion of the one or more bearing assemblies 536 stacked on top of each other are interposed between the surface 534 defining the one, or more pinion gear apertures 532 in the one or more pinion gears 466 and the outer surface 700 of the one or more trunnions 698 of the one or more spiders 690.

It is within the scope of this disclosure that the one or more shoulder portions 710 of the one or more spiders 690 may provide rotational support for at least a portion of the one or more pinion gears 466 and the one or more first bearing assemblies 536 of the differential assembly 600.

In accordance with the embodiment illustrated in FIG. 6 of the disclosure and as a non-limiting example, the differential assembly 600 may also include the use of the one or more second bearing assemblies 542. As illustrated in FIG. 6 of the disclosure, the one or more second bearing assemblies 542 are interposed between the radially outboard surface 524 of the one or more pinion gears 466 and the inner surface 704 of the differential case 708 of the differential assembly 600. According to an embodiment of the disclosure and as a non-limiting example, the one or more second bearing assemblies 542 may have a size and shape to aid in retaining the one or more first bearing assemblies 536 between the outer surface 700 of the one or more trunnions 698 and a surface 534 defining the one or more pinion gear apertures 532 in the one or more pinion gears 466.

As illustrated in FIG. 6 of the disclosure, the aperture 544 of the one or more second bearing assemblies 542 have a size and shape to receive and/or retain at least a portion of the one or more trunnions 698 of the one or more spiders 690 of the differential assembly 600. When assembled, at least a portion of the one or more rolling elements 546 of the one or more second bearing assemblies 542 are in direct contact with at least a portion of the inner surface 704 of the differential case 708 and/or are in direct contact with at least a portion of the radially outboard surface 524 of the one or more pinion gears 466. The one or more second bearing assemblies 542 reduce the overall amount of friction between the one or more pinion gears 466 and inner surface 704 of the differential case 708 when in operation. As a result, the one or more second bearing assemblies 542 of the differential assembly 600 aid in reducing the occurrence of and/or prevent the occurrence of a spin-out failure within the differential assembly 600 of the vehicle (not shown).

It is within the scope of this disclosure and as a non-limiting example that the differential assembly 600 may include the use of one or more first bearing spacers (not shown) interposed between the one or more first bearing assemblies 536 and the shoulder portion 710 of the one or more spiders 690. Additionally, it is within the scope of this disclosure and as a non-limiting example that the differential assembly 600 may include one or more second bearing spacers (not shown) interposed between the one or more first bearing assemblies 536 and the one or more second bearing assemblies 542 of the differential assembly 600. The one or more first and second bearing spacers (not shown) may be used to aid in the assembly of the differential assembly 600, provide rotational support and/or reduce the overall amount of friction between the one or more first and second bearing assemblies 536 and 542 when in operation.

Disposed directly adjacent to an end of the third plurality of input shaft splines 688 of the input shaft 618, opposite the first side gear 646, is a second reduced diameter portion 712.

Extending co-axially with the input shaft 618 of the differential assembly 600 is a second side gear 714 having a first end portion 716, a second end portion 718, an inner surface 720 and an outer surface 722. The inner surface 720 and the outer surface 722 of the second side gear 714 defines a hollow portion 724 therein. As illustrated in FIG. 6 of the disclosure and as a non-limiting example, the hollow portion 724 of the second side gear 714 has a size and shape to receive and/or retain at least a portion of the second reduced diameter portion 712 of the input shaft 618 of the differential assembly 600. Circumferentially extending along at least a portion of the outer surface 718 of the first end portion 716 of the second side gear 714 is an increased diameter portion 726.

As illustrated in FIG. 6 of the disclosure and as a non-limiting example, a plurality of side gear teeth 728 circumferentially extend from at least a portion of the outer surface 718 of the increased diameter portion 726 of the second side gear 714 of the differential gear set 648. The plurality of side gear teeth 728 are complementary to and meshingly engaged with the plurality of pinion gear teeth 530 on the outer surface 528 of the one or more pinion gears 466.

Extending co-axially with and drivingly connected to at least a portion of the second side gear 714 is a second shaft 730 having a first end portion 732, a second end portion (not shown) and an outer surface 734. Circumferentially extending from at least a portion of the outer surface 734 of the first end portion 732 of the second shaft 730 is a plurality of axially extending second shaft splines 736. As illustrated in FIG. 6 of the disclosure the plurality of axially extending second shaft splines 736 are complementary to and meshingly engaged with a plurality of axially extending side gear splines 738 circumferentially extending from at least a portion of the inner surface 720 of the second side gear 714.

Disposed radially outboard from at least a portion of the outer surface 722 of the second side gear 714 and adjacent to the increased diameter portion 726 of the second side gear 714 is a second tapered roller bearing assembly 730. As illustrated in FIG. 6 of the disclosure and as a non-limiting example, at least a portion of the second tapered roller bearing assembly 730 is interposed between the outer surface 718 of the second side gear 714 and the inner surface 608 of the axle housing 602. The second tapered roller bearing assembly 730 provides rotational support for the second side gear 714 and the second end portion 624 of the input shaft 618 of the differential assembly 600.

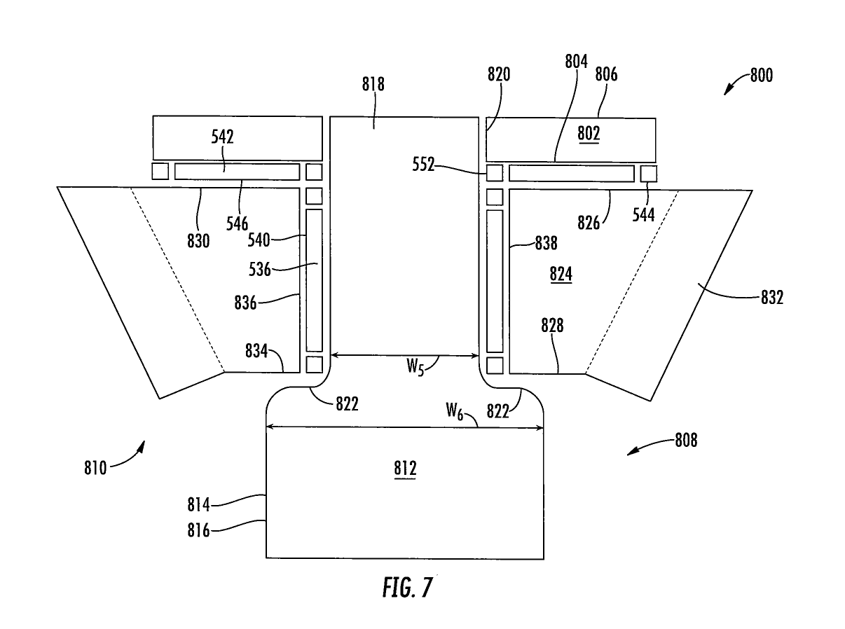

FIG. 7 is a cut-away schematic side-view of a portion of a differential assembly 800 according to another embodiment of the disclosure. The differential assembly 800 illustrated in FIG. 7 is the same as the differential assemblies 400 and 600 illustrated in FIGS. 5 and 6, except where specifically noted below. As illustrated in FIG. 7 of the disclosure, the differential assembly 800 includes a differential case 802 having an inner surface 804 and an outer surface 806 defining a hollow portion 808 therein. The hollow portion 808 of the differential case 802 is of a size and shape to receive and/or retain at least a portion of a differential gear set 810.

As illustrated in FIG. 7 of the disclosure, the differential assembly 800 includes one or more spiders 812 having a body portion 814. Extending outboard from at least a portion of an outer surface 816 of the body portion 814 of the one or more spiders 812 is one or more trunnions 818. The one or more trunnions 818 extend from the outer surface 816 of the body portion 814 of the one or more spiders 812 into one or more spider apertures 820 extending from the inner surface 808 to the outer surface 810 the differential case 802. The one or more spider apertures 820 are of a size and shape to receive and/or retain at least a portion of the one or more trunnions 818 of the one or more spiders 812 of the differential assembly 800. In accordance with an embodiment of the disclosure and as a non-limiting example, the one or more trunnions 818 of the one or more spiders 812 are substantially cylindrical in shape.

According to the embodiment of the disclosure illustrated in FIG. 7 and as a non-limiting example, the one or more trunnions 818 extending from the body portion 814 of the one or more spiders 812 have a width W5 that is less than a width W6 of the body portion 814 of the one or more spiders 812. In accordance with this embodiment of the disclosure, the one or more spiders 812 includes one or more shoulder portions 822 connecting the body portion 814 of the one or more spiders 812 to the one or more trunnions 818 of the one or more spiders 812.

As illustrated in FIG. 7 of the disclosure, the differential gear set 810 of the differential assembly 800 includes one or more pinion gears 824 having a radially outboard surface 826, a radially inboard surface 828 and an outer surface 830. Circumferentially extending along at least a portion of the outer surface 830 of the one or more pinion gears 824 of the differential gear set 810 of the differential assembly 800 is a plurality of pinion gear teeth 832. The plurality of pinion gear teeth 832 are complementary to the plurality of side gear teeth 728 of the second side gear 714, the second plurality of input helical gear teeth 660 of the first side gear 646, the plurality of first side gear teeth 478 of the first side gear 462 and/or the plurality of second side gear teeth 500 of the second side gear 464 illustrated in FIGS. 5 and 6 of the disclosure.

In accordance with the embodiment of the disclosure illustrated in FIG. 7 and as a non-limiting example, the radially outboard surface 826 of the one or more pinion gears 824 are substantially flat. Additionally, in accordance with the embodiment of the disclosure illustrated in FIG. 7 and as a non-limiting example, the radially inboard surface 828 of the one or more pinion gears 824 have one or more recessed portions 834. As illustrated in FIG. 7 of the disclosure and as a non-limiting example, the one or more recessed portions 834 of the one or more pinion gears 824 extend from the radially inboard surface 828 of the one or more pinion gears 824 toward the radially outboard surface 826 of the one or more pinion gears 824. The one or more recessed portions 834 of the one or more pinion gears 824 of the differential gear set 810 have a size and shape to receive and/or retain at least a portion of the one or more spiders 812 when the differential assembly 800 is assembled. It is within the scope of this disclosure that the one or more recessed portions 834 in the radially inboard surface 828 of the one or more pinion gears 824 aid in reducing the overall weight of the differential assembly 800. Additionally, it is within the scope of this disclosure and as a non-limiting example, that the one or more recessed portions 834 of the one or more pinion gears 824 of the differential assembly 800 aid in reducing the overall packaging size of the differential assembly 800. As a result, the differential assembly 800 will be able to be used in vehicles requiring a differential assembly with a smaller size.

Extending from the radially outboard surface 826 to the radially inboard surface 828 of the one or more spider gears 824 is one or more pinion gear apertures 836. The one or more pinion gear apertures 836 have a size and shape to receive and/or retain at least a portion of the one or more trunnions 818 of the one or more spiders 812 of the differential assembly 800.

Interposed between the outer surface 816 of the one or more trunnions 818 of the one or more spiders 812 and a surface 838 defining the one or more pinion gear apertures 836 in the one or more pinion gears 824 is the one or more first bearing assemblies 536. When assembled, at least a portion of the one or more rolling elements 540 of the one or more first bearing assemblies 536 are in direct contact with at least a portion of the surface 838 defining the one or more pinion gear apertures 836 and/or are in direct contact with at least a portion of the outer surface 816 of the one or more trunnions 818. The one or more first bearing assemblies 536 reduce the overall amount of friction between the one or more pinion gears 824 and the one or more trunnions 818 of the one or more spiders 812 when in operation. As a result, the one or more first bearing assemblies 536 of the differential assembly 800 aid in reducing the occurrence of and/or prevent the occurrence of a spin-out failure within the differential assembly 800 of the vehicle (not shown).

According to an alternative embodiment of the disclosure (not shown) and as a non-limiting example, the differential assembly 800 may include one or more bearing assemblies 536 that are stacked on top of each other. In accordance with this embodiment of the disclosure (not shown), at least a portion of the one or more bearing assemblies 536 stacked on top of each other are interposed between the surface 838 defining the one or more pinion gear apertures 836 in the one or more pinion gears 824 and the outer surface 816 of the one or more trunnions 818 of the one or more spiders 812.

It is within the scope of this disclosure that the one or more shoulder portions 822 of the one or more spiders 812 may provide rotational support for at least a portion of the one or more pinion gears 824 and the one or more first bearing assemblies 536 of the differential assembly 800.

In accordance with the embodiment illustrated in FIG. 7 of the disclosure and as a non-limiting example, the differential assembly 800 may also include the use of the one or more second bearing assemblies 542. As illustrated in FIG. 7 of the disclosure, the one or more second bearing assemblies 542 are interposed between the radially outboard surface 826 of the one or more pinion gears 824 and the inner surface 804 of the differential case 802 of the differential assembly 800. When assembled, at least a portion of the one or more rolling elements 546 of the one or more second bearing assemblies 542 are in direct contact with at least a portion of the inner surface 804 of the differential case 802 and/or are in direct contact with at least a portion of the radially outboard surface 830 of the one or more pinion gears 824. The one or more second bearing assemblies 542 reduce the overall amount of friction between the one or more pinion gears 824 and inner surface 804 of the differential case 802 when in operation. As a result, the one or more second bearing assemblies 542 of the differential assembly 800 aid in reducing the occurrence of and/or prevent the occurrence of a spin-out failure within the differential assembly 800 of the vehicle (not shown).

As illustrated in FIG. 7 of the disclosure, the spider trunnion aperture 552 in the body portion 544 of the one or more second bearing assemblies 542 is of a size and shape to receive and/or retain at least a portion of the one or more trunnions 818 of the one or more spiders 812 of the differential assembly 800.

It is within the scope of this disclosure and as a non-limiting example that the differential assembly 800 may include the use of one or more first bearing spacers (not shown) interposed between the one or more first bearing assemblies 536 and the shoulder portion 822 of the one or more spiders 812. Additionally, it is within the scope of this disclosure and as a non-limiting example that the differential assembly 800 may include one or more second bearing spacers (not shown) interposed between the one or more first bearing assemblies 536 and the one or more second bearing assemblies 542 of the differential assembly 800. The one or more first and second bearing spacers (not shown) may be used to aid in the assembly of the differential assembly 800, provide rotational support and/or reduce the overall amount of friction between the one or more first and second bearing assemblies 536 and 542 when in operation.

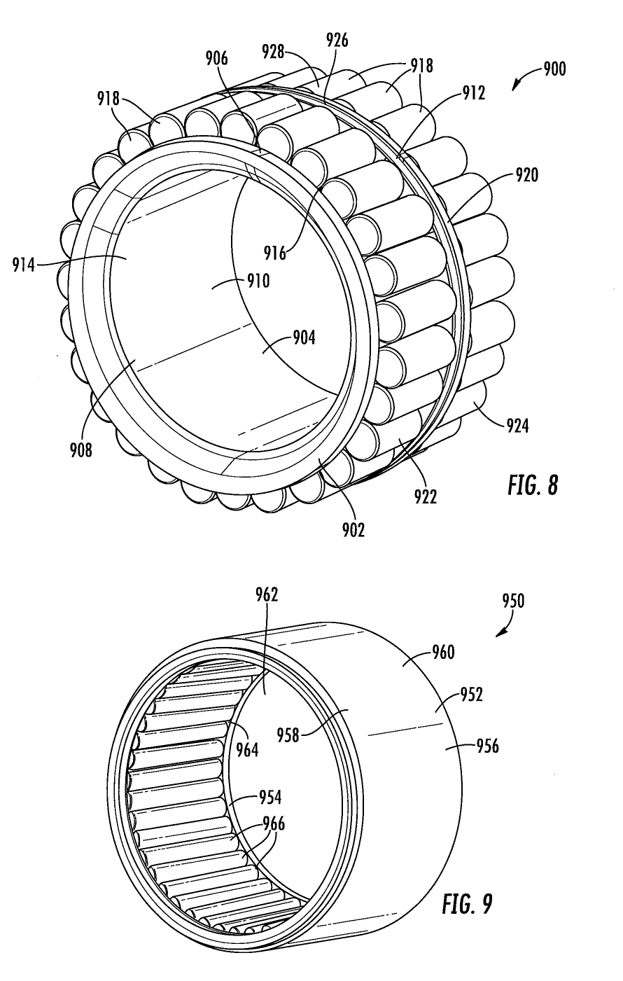

FIG. 8 is a perspective view of one or more first bearing assemblies 900 according to an embodiment of the disclosure. The one or more first bearing assemblies 900 illustrated in FIG. 8 is the same as the one or more first bearing assemblies 536 illustrated in FIGS. 5-7, except where specifically noted below. As illustrated in FIG. 8 of the disclosure, the one or more first bearing assemblies 900 have a body portion 902 having an inner surface 904, an outer surface 906, a first end portion 908, a second end portion 910 and an intermediate portion 912 interposed between the first and second end portions 908 and 910. The inner surface 904 and the outer surface 906 defines a hollow portion 914 therein.

In accordance with the embodiment illustrated in FIG. 8 of the disclosure and as a non-limiting example, the inner surface 904 of the body portion 902 of the one or more bearing assemblies 900 is substantially cylindrical in shape. When assembled, at least a portion of the inner surface 904 of the body portion 902 is in direct contact with at least a portion of the outer surface 516, 700 and/or 816 of the one or more trunnions 518, 698 and/or 818 of the one or more spiders 512, 690 and/or 812 of the differential assemblies 400, 600 and/or 800 illustrated in FIGS. 5-7.

Circumferentially extending along at least a portion of the outer surface 906 of the body portion 902 of the one or more first bearing assemblies 900 is one or more rolling element grooves 916. The one or more rolling element grooves 916 in the outer surface 906 of the body portion 902 of the one or more first bearing assemblies 900 are of a size and shape to receive and/or retain at least a portion of one or more rolling elements 918 of the one or more first bearing assemblies 900. When assembled, at least a portion of the one or more rolling elements 918 of the one or more first bearing assemblies 900 are in direct contact with at least a portion of the surface 534 and/or 838 defining the one or more pinion gear apertures 532 and/or 836 of the one or more pinion gears 466 and/or 824 of the differential assemblies 400, 600 and/or 800. As a result, in accordance with this embodiment of the disclosure and as a non-limiting example, the one or more rolling elements 918 of the one or more first bearing assemblies 900 are not in contact with the outer surface 516, 700 and/or 816 of the one or more trunnions 518, 698 and/or 818 of the one or more spiders 512, 690 and/or 812 of the differential assemblies 400, 600 and/or 800. As illustrated in FIG. 8 and as a non-limiting example, the one or more rolling elements 918 of the one or more first bearing assemblies 900 are substantially cylindrical in shape.

According to the embodiment of the disclosure illustrated in FIG. 8 and as a non-limiting example, the one or more first bearing assemblies 900 may further include the use of one or more separators 920. In accordance with the embodiment of the disclosure illustrated in FIG. 8 and as a non-limiting example, the one or more separators 920 are disposed along the intermediate portion 912 of the outer surface 906 of the body portion 902 of the one or more bearing assemblies 900. It is within the scope of this disclosure and as a non-limiting example, that the one or more separators 920 may be integrally formed as part of the outer surface 906 of the body portion 902 or may be connected to at least a portion of the outer surface 906 of the body portion 902 of the one or more first bearing assemblies 900. The one or more separators 920 of the one or more first bearing assemblies 900 separate the one or more rolling elements 918 into a first group of one or more rolling elements 922 and a second group of one or more rolling elements 924. When assembled, an outermost surface 926 of the one or more separators 920 have a diameter that is less than a diameter of an outermost surface 928 of the one or more rolling elements 918 of the one or more first bearing assemblies 900.

FIG. 9 is a perspective view of one or more first bearing assemblies 950 according to an alternative embodiment of the disclosure. The one or more first bearing assemblies 950 illustrated in FIG. 9 is the same as the one or more first bearing assemblies 536 and 900 illustrated in FIGS. 5-8, except where specifically noted below. As illustrated in FIG. 9 of the disclosure, the one or more first bearing assemblies 950 have a body portion 952 having an inner surface 954, an outer surface 956, a first end portion 958 and a second end portion 960. The inner surface 954 and the outer surface 956 defines a hollow portion 962 therein.

In accordance with the embodiment illustrated in FIG. 9 of the disclosure and as a non-limiting example, the outer surface 956 of the body portion 952 of the one or more first bearing assemblies 950 is substantially cylindrical in shape. When assembled, at least a portion of the outer surface 956 of the body portion 952 is in direct contact with at least a portion of the surface 534 and/or 838 of the one or more pinion gear apertures 532 and/or 836 of the one or more pinion gears 466 and/or 824 of the differential assemblies 400, 600 and/or 800 illustrated in FIGS. 5-7.

Circumferentially extending along at least a portion of the inner surface 954 of the body portion 952 of the one or more first bearing assemblies 950 is one or more rolling element grooves 964. The one or more rolling element grooves 916 in the inner surface 954 of the body portion 952 of the one or more first bearing assemblies 950 are of a size and shape to receive and/or retain at least a portion of one or more rolling elements 966 of the one or more first bearing assemblies 950. When assembled, at least a portion of the one or more rolling elements 966 of the one or more first bearing assemblies 950 are in direct contact with at least a portion of the outer surface 516, 700 and/or 816 of the one or more trunnions 518, 698 and/or 818 of the one or more spiders 512, 690 and/or 812 of the differential assemblies 400, 600 and/or 800 illustrated in FIGS. 5-7. As a result, in accordance with this embodiment of the disclosure and as a non-limiting example, the one or more rolling elements 966 of the one or more first bearing assemblies 950 are not in contact with the surface 534 and/or 838 of the one or more pinion gear apertures 532 and/or 836 of the one or more pinion gears 466 and/or 824. As illustrated in FIG. 9 and as a non-limiting example, the one or more rolling elements 966 are substantially cylindrical in shape.

According to an embodiment of the disclosure (not shown) and as a non-limiting example, the one or more first bearing assemblies 950 may further include the use of one or more separators (not shown). The one or more separators (not shown) may be used to separate the one or more rolling elements 966 of the one or more first bearing assemblies 950 into one or more groups. When assembled, an outermost surface (not shown) of the one or more separators (not shown)have a diameter that is less than an outermost diameter of the one or more rolling elements 966 of the one or more first bearing assemblies 950.

FIG. 10 is a perspective view of one or more first bearing assemblies 1000 according to another embodiment of the disclosure. The one or more first bearing assemblies 1000 illustrated in FIG. 10 is the same as the one or more first bearing assemblies 536, 900 and 950 illustrated in FIGS. 5-9, except where specifically noted below. As illustrated in FIG. 10 of the disclosure, the body portion 1002 of the one or more first bearing assemblies 1000 have an inner surface 1004 and an outer surface 1006 defining a hollow portion 1008 therein. It is within the scope of this disclosure and as a non-limiting example, that the body portion 1002 of the one or more first earing assemblies 1000 are substantially cylindrical in shape.

Extending from the inner surface 1004 to the outer surface 1006 of the body portion 1002 of the one or more first bearing assemblies 1000 is one or more rolling element apertures 1010. The one or more rolling element apertures 1010 of the body portion 1002 of the one or more first bearing assemblies 1000 are of a size and shape to receive and/or retain at least a portion of one or more rolling elements 1012. In accordance with the embodiment of the disclosure illustrated in FIG. 10 and as a non-limiting example, the one or more rolling elements 1012 of the one or more first bearing assemblies 1000 are substantially spherical in shape.

When assembled, at least a portion of the one or more rolling elements 1012 of the one or more first bearing assemblies 1000 are in direct contact with at least a portion of the surface 534 and/or 838 defining the one or more pinion gear apertures 532 and/or 836 of the one or more pinion gears 466 and/or 824, and/or are in direct contact with at least a portion of the outer surface 516, 700 and/or 816 of the one or more trunnions 518, 698 and/or 818. Additionally, when assembled, the body portion 1002 of the one or more first bearing assemblies 1000 are not in direct contact with the surfaces 534 and/or 838 of the one or more pinion gear apertures 532 and/or 836, and/or the outer surface 516, 700 and/or 816 of the one or more trunnions 518, 698 and/or 818 of the differential assemblies 400, 600 and/or 800.

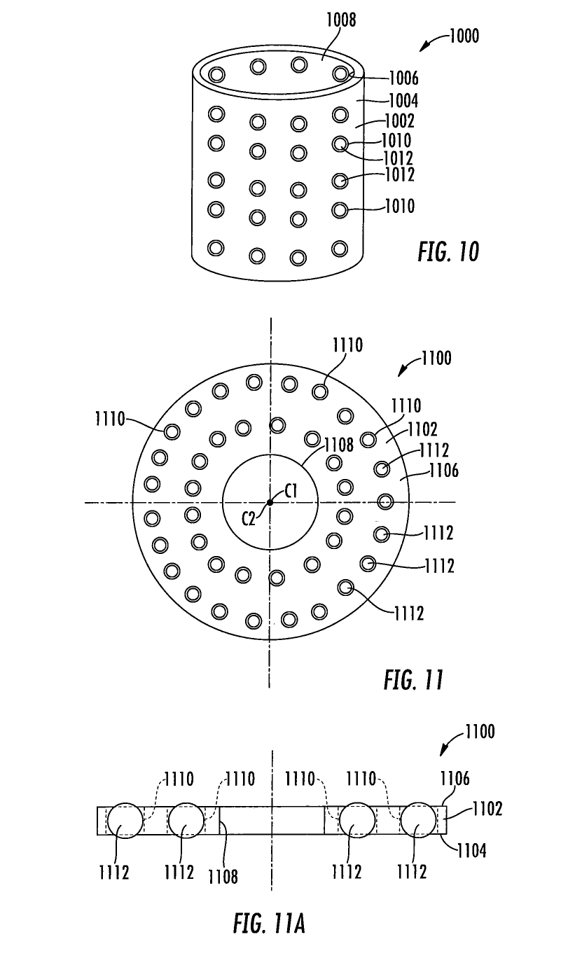

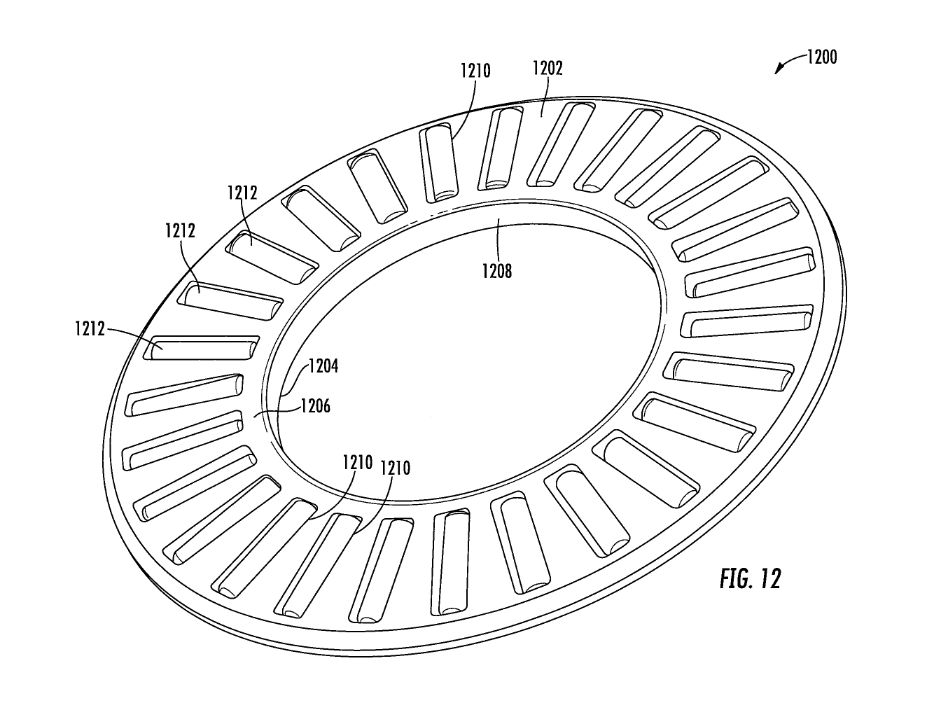

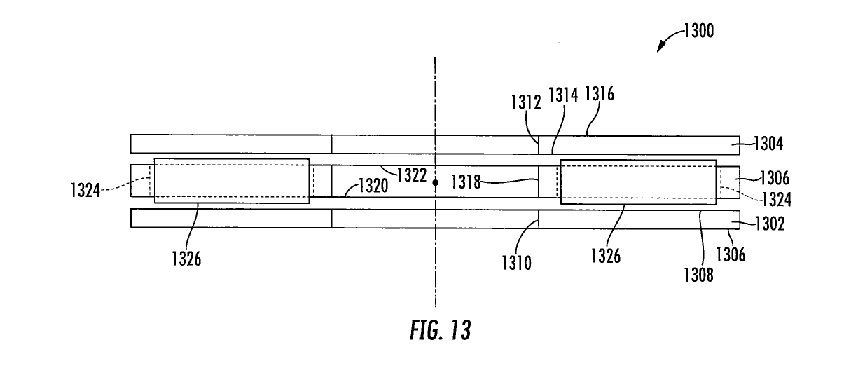

FIGS. 11 and 11A schematically illustrate one or more second bearing assemblies 1100 according to an embodiment of the disclosure. The one or more second bearing assemblies 1100 illustrated in FIGS. 11 and 11A is the same as the one or more second bearing assemblies 1100 illustrated in FIGS. 5-7, except where specifically noted below. As best seen in FIG. 11A of the disclosure, the one or more second bearing assemblies 1100 have a body portion 1102 having an inner surface 1104 and an outer surface 1006. In accordance with the embodiment of the disclosure illustrated in FIGS. 11 and 11A and as a non-limiting example, the one or more second bearing assemblies 1100 are substantially disk-shaped.

Extending from the inner surface 1104 to the outer surface 1106 of the body portion 1102 of the one or more second bearing assemblies 1100 is a spider trunnion aperture 1108. As best seen in FIG. 11 of the disclosure and as a non-limiting example, the theoretical center C1 of the spider trunnion aperture 1108 in the body portion 1102 of the one or more second bearing assemblies 1100 is located in substantially the same location as the theoretical center C2 of the body portion 1102 of the one or more second bearing assemblies 1100. The spider trunnion aperture 1108 in the body portion 1102 of the one or more second bearing assemblies 1100 has a size and shape to receive and/or retain at least a portion of the one or more trunnions 518, 698 and/or 818 of the one or more spiders 512, 690 and/or 812 of the differential assemblies 400, 600 and 800.

As best seen in FIG. 11A of the disclosure and as a non-limiting example, the one or more second bearing assemblies 1100 may include one or more rolling element apertures 1110 extending from the inner surface 1104 to the outer surface 1106 of the body portion 1102 of the one or more second beating assemblies 1100. The one or more rolling element apertures 1110 in the body portion 1102 of the one or more second bearing assemblies 1100 are of a size and shape to receive and/or retain at least a portion of one or more rolling elements 1112. In accordance with the embodiment of the disclosure illustrated in FIGS. 11 and 11A and as a non-limiting example, the one or more rolling elements 1112 of the one or more second bearing assemblies 1100 are substantially spherical in shape.

When assembled, at least a portion of the one or more rolling elements 1112 of the one or more second bearing assemblies 1100 are in direct contact with at least a portion of the inner surface 408, 704 and/or 804 of the differential case 402, 708 and/or 802, and/or are in direct contact with at least a portion of the radially outboard surface 524 and/or 826 of the one or more pinion gears 466 and/or 824. Additionally, when assembled, the body portion 1102 of the one or more second bearing assemblies 1100 are not in direct contact with the inner surface 408, 704 and/or 804 of the differential case 402, 708 and/or 802, and/or the radially outboard surface 524 and/or 826 of the one or more pinion gears 466 and/or 824 of the differential assemblies 400, 600 and/or 800.

FIG. 12 is a schematic perspective view of one or more second bearing assemblies 1200 according to an alternative embodiment of the disclosure. The one or more second bearing assemblies 1200 illustrated in FIG. 12 are the same as the one or more second bearing assemblies 542 and 1100 illustrated in FIGS. 5-7, 11 and 11A, except where specifically noted below. As illustrated in FIG. 12 of the disclosure, the one or more second bearing assemblies 1200 has a body portion 1202 having an inner surface 1204 and an outer surface 1206. In accordance with the embodiment of the disclosure illustrated in FIG. 12 of the disclosure and as a non-limiting example, the one or more second bearing assemblies 1200 are substantially disk-shaped.

Extending from the inner surface 1204 to the outer surface 1206 of the body portion 1202 of the one or more second bearing assemblies 1200 is a spider trunnion aperture 1208. According to an embodiment of the disclosure and as a non-limiting example, the theoretical center of the spider trunnion aperture 1208 in the body portion 1202 of the one or more second bearing assemblies 1200 is located in substantially the same location as the theoretical center of the body portion 1202 of the one or more second bearing assemblies 1200. The spider trunnion aperture 1208 in the body portion 1202 of the one or more second bearing assemblies 1200 has a size and shape to receive and/or retain at least a portion of the one or more trunnions 518, 698 and/or 818 of the one or more spiders 512, 690 and/or 812 of the differential assemblies 400, 600 and 800.

As illustrated in FIG. 12 of the disclosure and as a non-limiting example, the one or more second bearing assemblies 1200 may include one or more rolling element apertures 1210 extending from the inner surface 1204 to the outer surface 1206 of the body portion 1202 of the one or more second beating assemblies 1200. The one or more rolling element apertures 1210 in the body portion 1202 of the one or more second bearing assemblies 1200 are of a size and shape to receive and/or retain at least a portion of one or more rolling elements 1212. In accordance with the embodiment of the disclosure illustrated in FIG. 12 and as a non-limiting example, the one or more rolling elements 1212 of the one or more second bearing assemblies 1200 are substantially cylindrical in shape in shape.

When assembled, at least a portion of the one or more rolling elements 1212 of the one or more second bearing assemblies 1200 are in direct contact with at least a portion of the inner surface 408, 704 and/or 804 of the differential case 402, 708 and/or 802, and/or are in direct contact with at least a portion of the radially outboard surface 524 and/or 826 of the one or more pinion gears 466 and/or 824. Additionally, when assembled, the body portion 1202 of the one or more second bearing assemblies 1200 are not in direct contact with the inner surface 408, 704 and/or 804 of the differential case 402, 708 and/or 802, and/or the radially outboard surface 524 and/or 826 of the one or more pinion gears 466 and/or 824 of the differential assemblies 400, 600 and/or 800.

FIG. 13 is a cut-away schematic side-view of one or more second bearing assemblies 1300 according to another embodiment of the disclosure. The one or more second bearing assemblies 1300 illustrated in FIG. 13 is the same as the one or more second bearing assemblies 542, 1100 and 1200 illustrated in FIGS. 5-7 and 11-12, except where specifically noted below. As illustrated in FIG. 13 of the disclosure and as a non-limiting example, the one or more second bearing assemblies 1300 includes an inner race 1302, an outer race 1304 and a body portion 1306 interposed between the inner and outer races 1302 and 1304 of the one or more second bearing assemblies 1300.

Extending from an inner surface 1306 to an outer surface 1308 of the inner race 1302 of the one or more second bearing assemblies 1300 is an inner race spider trunnion aperture 1310. The inner race spider trunnion aperture 1310 of the inner race 1302 is of a size and shape to receive and/or retain at least a portion of the one or more trunnions 51, 698 and/or 818 of the one or more spiders 512, 690 and/or 812 of the differential assemblies 400, 600 and/or 800 illustrated in FIGS. 5-7. When assembled, at least a portion of the inner surface 1306 of the inner race 1302 of the one or more second bearing assemblies 1300 are in direct contact with at least a portion of the radially outboard surface 524 and/or 826 of the one or more pinion gears 466 and/or 824 of the differential assemblies 400, 600 and/or 800.

An outer race spider trunnion aperture 1312 extends from an inner surface 1314 to an outer surface 1316 of the one or more second bearing assemblies 1300. The outer race spider trunnion aperture 1312 of the outer race 1304 is of a size and shape to receive and/or retain at least a portion of the one or more trunnions 51, 698 and/or 818 of the one or more spiders 512, 690 and/or 812 of the differential assemblies 400, 600 and/or 800 illustrated in FIGS. 5-7. When assembled, at least a portion of the outer surface 1316 of the outer race 1304 of the one or more second bearing assemblies 1300 are in direct contact with at least a portion of the inner surface 408, 704 and/or 804 of the differential case 402, 708 and/or 802 of the differential assemblies 400, 600 and/or 800.

As illustrated in FIG. 13 of the disclosure and as a non-limiting example, the body portion 1306 of the one or more second bearing assemblies 1300 has a spider trunnion aperture 1318 extending from an inner surface 1320 to an outer surface 1322 of the body portion 1306. Additionally, as illustrated in FIG. 13 of the disclosure, the inner race spider trunnion aperture 1310, the body portion spider trunnion aperture 1318 and the outer race spider trunnion aperture 1312 are aligned with one another. In accordance with an embodiment of the disclosure and as a non-limiting example, the theoretical center of the spider trunnion aperture 1318 in the body portion 1306 of the one or more second bearing assemblies 1300 is located in substantially the same location as the theoretical center of the body portion 1306 of the one or more second bearing assemblies 1300. The spider trunnion aperture 1318 in the body portion 1306 of the one or more second bearing assemblies 1300 has a size and shape to receive and/or retain at least a portion of the one or more trunnions 518, 698 and/or 818 of the one or more spiders 512, 690 and/or 812 of the differential assemblies 400, 600 and 800.

Extending from the inner surface 1320 to the outer surface 1322 of the body portion 1306 of the one or more second bearing assemblies 1300 is one or more rolling element apertures 1324. The one or more rolling element apertures 1324 in the body portion 1306 of the one or more second bearing assemblies 1300 are of a size and shape to receive and/or retain at least a portion of one or more rolling elements 1326. According to the embodiment of the disclosure illustrated in FIG. 13 and as a non-limiting example, the body portion 1306 of the one or more second bearing assemblies 1300 act as a cage for the one or more rolling elements 1326 in order to ensure that they are retained in their ideal location when in operation. In accordance with the embodiment of the disclosure illustrated in FIG. 13 and as a non-limiting example, the one or more rolling elements 1326 of the one or more second bearing assemblies 1300 are substantially cylindrical in shape in shape.

When assembled, at least a portion of the one or more rolling elements 1326 of the one or more second bearing assemblies 1300 are in direct contact with at least a portion of the inner surface 1314 of the outer race 1305 and at least a portion of the outer surface 1308 of the inner race 1302. As a result, in accordance with the embodiment of the disclosure illustrated in FIG. 13 and as a non-limiting example, the one or more rolling elements 1326 are not in direct contact with the radially outboard surface 524 and/or 826 of the one or more pinion gears 466 and/or 824, and are not in direct contact with the inner surface 408, 704 and/or 804 of the differential case 402, 708 and/or 802.

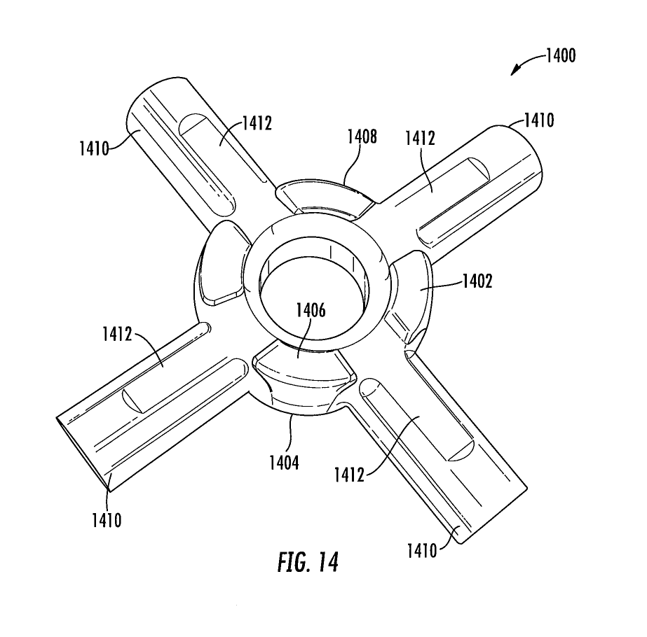

FIG. 14 is a schematic perspective view of a spider 1400 according to an embodiment of the disclosure. The spider 1400 illustrated in FIG. 14 is the same as the one or more spiders 512, 690 and 812 illustrated in FIGS. 5-7, except where specifically noted below. As illustrated in FIG. 14 of the disclosure, the spider 1400 includes a body portion 1402 having a first side 1404, a second side 1406 and an outer surface 1406. Extending from at least a portion of the outer surface 1408 of the body portion 1402 of the spider 1400 is one or more trunnions 1410. As a non-limiting example, the one or more trunnions 1410 of the spider 1400 are substantially cylindrical in shape.

In accordance with the embodiment of the disclosure illustrated in FIG. 14 and as a non-limiting example, one or more first lubrication grooves 1412 extend along at least a portion of the outer surface 1408 of the second side 1406 of the body portion 1402 and/or the one or more trunnions 1410 of the spider 1400. According to an alternative embodiment of the disclosure (not shown) and as a non-limiting example, the spider 1400 may also include one or more second lubrication grooves (not shown) extending along at least a portion of the outer surface 1408 of the first side 1404 of the body portion 1402 and/or the one or more trunnions 1410 of the spider 1400. The one or more first lubrication grooves 1412 and/or the one or more second lubrication grooves (not shown) allow for the flow of a pre-determined amount of lubrication fluid to the one or more first bearing assemblies 536, 900, 950 and 1000 and/or to the one or more second bearing assemblies 542, 1100, 1200 and 1300. This will aid in improving the overall life and durability of the differential assembly. Additionally, this will aid in reducing the occurrence of and/or prevent the occurrence of a spin-out failure within the differential assembly 400, 600 and/or 800 of the vehicle (not shown).

While the above-disclosure describes the one or more first bearing assemblies 536, 900, 950 and 1000 are described to have one or more rolling elements 536, 900, 950 and 1000, it is within the scope of this disclosure and as a non-limiting example that the one or more of the one or more first bearing assemblies 536, 900, 950 and/or 1000 may be one or more first bushings. Additionally, while he one or more second bearing assemblies 542, 1100, 1200 and 1300 are described to have one or more rolling elements 546, 1100, 1200 and 1300 it is within the scope of this disclosure and as a non-limiting example that one or more of the one or more second bearing assemblies 542, 1100, 1200 and 1300 may be one or more second bushings.

It is within the scope of this disclosure that the various embodiments of the disclosure described and illustrated herein may be combined with one another to make an axle system according to an embodiment of the disclosure.

In accordance with the provisions of the patent statutes, the present invention has been described to represent what is considered to represent the preferred embodiments. However, it should be noted that this invention can be practiced in other ways than those specifically illustrated and described without departing from the spirit or scope of this invention.

What is claimed is:

1. A differential assembly, comprising:
a differential case having an inner surface and an outer surface defining a hollow portion therein;
one or more spiders;
wherein one or more trunnions extend from an outer surface of a body portion of said one or more spiders;
a differential gear set comprising a first side gear, a second side gear and one or more pinion gears;
wherein at least a portion of said differential gear set is disposed within said hollow portion of said differential case;
wherein said one or more pinion gears have one or more pinion gear apertures extending from a radially outboard surface of said one or more pinion gears to a radially inboard surface of said one or more pinion gears;
wherein at least a portion of said one or more trunnions of said one or more spiders are disposed within at least a portion of said one or more pinion gear apertures in said one or more pinion gears of said differential gear set;
one or more first bearing assemblies; and
wherein said one or more first bearing assemblies are interposed between said outer surface of said one or more trunnions of said one or more spiders and a surface defining said one or more pinion gear apertures in said one or more pinion gears of said differential gear set.

2. The differential assembly of claim 1, wherein said radially outboard surface and/or said radially inboard surface of said one or more pinion gears of said differential gear set are substantially flat.

3. The differential assembly of claim 1, wherein said radially inboard surface of said one or more pinion gears of said differential gear set has one or more recessed portions; and
wherein said one or more recessed portions in said radially inboard surface of said one or more pinion gears of said differential gear set are of a size and shape to receive and/or retain at least a portion of said one or more spiders.

4. The differential assembly of claim 1, wherein said first side gear of said differential gear set is an input helical side gear.

5. The differential assembly of claim 4, further comprising an input shaft; and
wherein said body portion of said one or more spiders is drivingly connected to at least a portion of said input shaft.

6. The differential assembly of claim 1, wherein said one or more first bearing assemblies are substantially cylindrical in shape.

7. The differential assembly of claim 1, wherein said one or more first bearing assemblies comprises a body portion; and
wherein said body portion of said one or more first bearing assemblies has a size and shape to receive and/or retain at least a portion of one or more rolling elements therein.

8. The differential assembly of claim 1, where said one or more first bearing assemblies comprises a body portion having an having an inner surface, an outer surface a first end portion, a second end portion and an intermediate portion;
wherein said intermediate portion of said body portion of said one or more first bearing assemblies is interposed between said first and second end portions of said body portion;
wherein one or more rolling element grooves circumferentially extend along at least a portion of said outer surface of said body portion of said one or more first bearing assemblies; and
wherein said one or more rolling element grooves have a size and shape to receive and/or retain at least a portion of one or more rolling elements of said one or more first bearing assemblies.

9. The differential assembly of claim 8, further comprising a one or more separators;
wherein said one or more separators of said one or more first bearing assemblies are disposed along said outer surface of said intermediate portion of said body portion of said one or more first bearing assemblies; and
wherein said one or more separators separates said one or more rolling elements of said one or more first bearing assemblies into a first group or one or more rolling elements and a second group of one or more rolling elements.

10. The differential assembly of claim 1, where said one or more first bearing assemblies comprises a body portion having an having an inner surface and an outer surface;
wherein one or more rolling element grooves circumferentially extend along at least a portion of said inner surface of said body portion of said one or more first bearing assemblies; and
wherein said one or more rolling element grooves have a size and shape to receive and/or retain at least a portion of one or more rolling elements of said one or more first bearing assemblies.

11. The differential assembly of claim 1, wherein said one or more bearing assemblies comprises a body portion having an inner surface and an outer surface;
wherein said body portion of said one or more first bearing assemblies has one or more rolling element apertures extending from said inner surface to said outer surface of said body portion of said one or more first bearing assemblies;
wherein said one or more rolling element apertures have a size and shape to receive and/or retain at least a portion of said one or more rolling elements; and
wherein said one or more rolling elements of said one or more first bearing assemblies are substantially cylindrical in shape.

12. The differential assembly of claim 1, further comprising one or more second bearing assemblies;
wherein said one or more second bearing assemblies are interposed between said inner surface of said differential case and said radially outboard surface of said one or more pinion gears of said differential gear set.

13. The differential assembly of claim 12, wherein said one or more second bearing assemblies are substantially disk-shaped.

14. The differential assembly of claim 12, wherein said one or more second bearing assemblies comprises a body portion;
wherein said body portion of said one, or more second bearing assemblies has a size and shape to receive and/or retain at least a portion of one or more rolling elements therein;
wherein said body portion of said one or more second bearing assemblies has a spider trunnion aperture extending from said inner surface to said outer surface of said body portion of said one or more second bearing assemblies; and
wherein said spider trunnion aperture is of a size and shape to receive and/or retain at least a portion of said one or more trunnions of said one or more spiders.

15. The differential assembly of claim 14, further comprising an inner race and an outer race;
wherein said inner race is interposed between an inner surface of said body portion of said one or more second bearing assemblies and said radially outboard surface of said one or more pinion gears of said differential gear set;
wherein said inner race has an inner race spider trunnion aperture extending from an inner surface to an outer surface of said inner race;
wherein said inner race spider trunnion aperture is of a size and shape to receive and/or retain at least a portion of said one or more trunnions of said one or more spiders;
wherein said outer race is interposed between an outer surface of said body portion of said one or more second bearing assemblies and said inner surface of said differential case;
wherein said outer race has an outer race spider trunnion aperture extending from an inner surface to an outer surface of said outer race;
wherein said outer race spider trunnion aperture is of a size and shape to receive and/or retain at least a portion of said one or more trunnions of said one or more spiders;

16. The differential assembly of claim 12, wherein said one or more second bearing assemblies comprises a body portion having an inner surface and an outer surface;
wherein said body portion of said one or more second bearing assemblies has a spider trunnion aperture extending from said inner surface to said outer surface of said body portion of said one or more second bearing assemblies;
wherein said spider trunnion aperture is of a size and shape to receive and/or retain at least a portion of said one or more trunnions of said one or more spiders;
wherein said body portion of said one or more second bearing assemblies has one or more rolling element apertures extending from said inner surface to said outer surface of said body portion of said one or more second bearing assemblies;
wherein said one or more rolling element apertures have a size and shape to receive and/or retain at least a portion of one or more rolling elements; and
wherein said one or more rolling elements of said one or more second bearing assemblies are substantially cylindrical and/or substantially spherical in shape.

17. The differential assembly of claim 1, wherein said one or more spiders further comprises one or more lubrication grooves extending along at least a portion of said outer surface of said body portion and/or said one or more trunnions of said one or more spiders.
